(19) United States
(12) Patent Application Publication
(10) Pub. No.: US 2022/0146300 A1
(43) Pub. Date: May 12, 2022

(54) TROLLEY FOR SUPPORTING AND WEIGHING A CONTAINER

(71) Applicant: KNAP, Biot (FR)

(72) Inventors: Dylan LETIERCE, Peymeinade (FR); Jonathan MALOGNE, Auribeau (FR); Christophe CHALOIN, Le Cannet (FR)

(21) Appl. No.: 17/600,798

(22) PCT Filed: Apr. 1, 2020
(86) PCT No.: PCT/EP2020/059311

§ 371 Date: Oct. 1, 2021

(30) Foreign Application Priority Data
Apr. 3, 2019 (FR) 1903591
Jun. 17, 2019 (FR) 1906492
Dec. 5, 2019 (FR) 1913820

(51) Int. Cl. G01G 19/08; G01G 3/14; B62B 3/14; B62B 5/00; B62B 5/06; B62B 3/18

(52) U.S. Cl. CPC G01G 19/08; G01G 3/14; B62B 3/1492; B62B 2203/50; B62B 5/06; B62B 3/184; B62B 2203/02; B62B 5/00

(57) ABSTRACT

A trolley, for example for a supermarket, including at least one chassis, a load-bearing structure supported by the chassis, a suspension structure supported by the load-bearing structure configured to suspend at least one container. The trolley includes at least one measurement device at least partially carried by the suspension structure and for measuring at least one parameter relating to the weight of the at least one container when the container is suspended from the suspension structure.

### TECHNICAL FIELD

The invention relates to the field of transport trolleys. It is in particular applicable to retail outlets such as supermarkets. More specifically, it relates to the integration of measurement devices into trolleys in order to weigh the items selected by the user and placed in the trolley.

### PRIOR ART

Supermarkets are known to provide self-service checkout devices, known as self-checkouts, which allow shoppers to calculate the cost of and pay for their groceries once they have all been placed in the trolley. This comprises a step of scanning each item using an optical scanner, and then a step of weighing each selected item. This weighing step in particular ensures that each item placed by the user in the trolley has been scanned and thus included in the sum to be paid. These self-checkouts as described are often made available to users firstly in order to limit long and tedious queues at the checkout and secondly to increase the number of checkout operations per unit of time and thus increase the productivity of the supermarkets.

In order to completely eliminate these long and tedious queues, trolleys currently exist which are themselves designed to weigh the items selected by the user.

However, these trolleys are often not user-friendly. More specifically, these trolleys are not easy to handle.

Moreover, these trolleys often suffer from frequent malfunctions and often lack precision. As a result, discrepancies are indicated between the items placed in the trolley and those accounted for after the scanning step. This makes it impossible to effectively identify attempted fraud. On the other hand, this situation is also delicate in that it can be uncomfortable for honest users. Another drawback of this type of trolley is that they are often bulky, which makes them difficult to store.

There is thus a need to propose a solution to reduce or even eliminate at least some of the aforementioned drawbacks.

The present invention aims to meet this need.

Other purposes, features and advantages of the present invention will appear upon reading the following description and the accompanying drawings. It is understood that other advantages can be incorporated therein.

### SUMMARY

According to one aspect, the invention relates to a trolley, for example for a supermarket, comprising:
at least one chassis supported by at least three bearing members configured to isostatically support the trolley on a ground, at least two of said at least three members each comprising at least one rolling device, such as a wheel,
a load-bearing structure supported by the chassis.

Preferably, the trolley comprises at least one container in which at least one product is intended to be placed.

Preferably, the trolley comprises a suspension structure supported by the load-bearing structure and configured to suspend at least one container in which at least one product is intended to be placed. The trolley is configured such that the at least one container is fully suspended from the suspension structure, for example by receiving areas.

Preferably, the trolley comprises at least one measurement device at least partially carried by the suspension structure and intended to measure at least one parameter relating to the weight of the at least one container when the container is suspended from the suspension structure.

Optionally, but advantageously, the suspension structure, advantageously the frame, the at least one container and the chassis of said trolley are shaped so as to cooperate with a suspension structure, advantageously a frame, at least one container and a chassis of another trolley so as to allow at least a part of said other trolley to be at least partially nested in at least a part of said trolley by cooperation between the suspension structure, advantageously the frame, the at least one container and the chassis of said other trolley, and the suspension structure, advantageously the frame, the at least one container and the chassis of said trolley.

Optionally, but advantageously, the suspension structure, advantageously the frame, the at least one container and the chassis of said trolley are shaped so as to cooperate with the suspension structure, advantageously the frame, the at least one container and the chassis of another trolley so as to allow at least a part of said trolley to be at least partially nested in at least a part of said other trolley by cooperation between the suspension structure, advantageously the frame, the at least one container and the chassis of said trolley, and the suspension structure, advantageously the frame, the at least one container and the chassis of said other trolley.

Thus, a part of a first trolley penetrates a second trolley and another part of the second trolley simultaneously penetrates the first trolley.

Optionally, but advantageously, the suspension structure of said trolley is shaped to cooperate with the suspension structure of another trolley so as to allow said trolley to be at least partially nested in said other trolley by cooperation between the suspension structure of said trolley and the suspension structure of said other trolley. According to one embodiment, preferably, the suspension structure of said trolley is shaped to cooperate with the suspension structure of another trolley so as to allow the load-bearing structure of said trolley to be at least partially nested in a load-bearing structure of said other trolley.

Thus, the present invention provides the user with a trolley that allows the at least one container and the at least one product that the user wishes to purchase to be weighed, while allowing the user to store the trolley easily and in a space-saving manner. These two functions are in particular made possible by the presence of the suspension structure.

Moreover, the present invention allows supermarkets both to combat existing fraud using known self-checkout systems and to save a considerable amount of space when storing the trolley when not in use.

The present invention integrates very few mechanical, moving or displacing parts. This increases the robustness and reliability of the present invention.

More specifically, trolleys are regularly mistreated by users, so robust trolleys are of great interest. The present invention, in addition to the multiple innovations in design and use that it affords, provide for a robust trolley.

The physical features (size, container, etc.) of the present invention are also optimised. These features also allow for the integration of containers in the form of bags or in other forms.

According to another aspect, the invention relates to an assembly comprising a trolley according to the invention and at least one container, preferably a plurality of containers, each container being configured to cooperate with the suspension structure such that the container is fully suspended by the suspension structure.

### BRIEF DESCRIPTION OF THE FIGURES

The aims, purposes, features and advantages of the invention will be better understood upon reading the detailed description of one embodiment thereof, which is illustrated by means of the following accompanying drawings, in which:

FIG. 1 shows a first external view of the trolley according to a first embodiment of the present invention.

FIG. 2 shows a second external view of the trolley in FIG. 1.

FIG. 3 shows a front view of the trolley in FIG. 1.

FIG. 4 shows a rear view of the trolley in FIG. 1.

FIG. 5 shows a side view of the trolley in FIG. 1.

FIG. 6 shows a sectional view through the length of the trolley in FIG. 1.

FIG. 7 shows an external view of the tray suspended from the trolley in FIG. 1.

FIG. 8 shows an external view of the trolley in FIG. 1 when in use.

FIG. 9 shows a sectional view of the trolley in FIG. 1 when in use.

FIG. 10 shows an external view of the suspension bar of the trolley in FIG. 1.

FIG. 11 shows a sectional view of the suspension bar of the trolley in FIG. 1.

FIG. 12 shows a side view of the trolley according to a first embodiment.

FIG. 13 shows a side view of the trolley according to a first embodiment.

FIG. 14 shows an external view of the trolley according to a first embodiment.

FIG. 15 shows a side view of the nesting of two trolleys according to a first embodiment.

FIG. 16 shows an external view of the nesting of the two trolleys according to a second embodiment.

FIG. 17 shows a side view of the nesting of three trolleys according to a first embodiment.

FIG. 18 shows an external view of the nesting of three trolleys according to a first embodiment.

FIG. 19 shows an external view of the first and second arms of the trolley according to a second embodiment.

FIG. 20 shows a side view of the nesting of the first arms of two trolleys according to a second embodiment.

FIG. 21 shows an external view of the nesting of the arms of two trolleys according to a second embodiment.

FIG. 22 shows an external view of the recipient of the trolley according to a third embodiment.

FIG. 23 shows an external view of the nesting of the two recipients of two trolleys according to a third embodiment.

FIG. 24 shows an overhead view of the nesting of the two recipients of two trolleys according to a third embodiment.

FIG. 25 shows an external view of the first arm and of the second arm of the trolley according to a fourth embodiment.

FIG. 26 shows an overhead view of the first arms and second arms of two trolleys when they are nested according to a fourth embodiment.

FIG. 27 shows an external view of the first arms and second arms of two trolleys when they are nested according to a fourth embodiment.

FIG. 28 shows an external view of the chassis of the trolley according to a fifth embodiment.

FIG. 29 shows an overhead view of the nesting of the chassis of two trolleys according to a fifth embodiment.

FIG. 30 shows an external view of the nesting of two chassis of two trolleys according to a fifth embodiment.

FIG. 31 shows an external view of the trolley with the frame according to the third embodiment.

FIG. 32 shows a sectional view of the trolley with the frame according to the second embodiment.

FIG. 33 shows a perspective view of another embodiment in which the suspension structure is rotatably mounted on the trolley. In this figure, the trolley is in the carrying configuration.

FIG. 34 shows a sectional view of a plurality of trolleys according to the embodiment shown in

FIG. 33, the trolleys being in the storage configuration and being nested in one another.

FIG. 35 shows a perspective view of another embodiment.

FIG. 36 shows a profile view of a plurality of trolleys according to the embodiment shown in FIG. 35, the trolleys being in the storage configuration and being nested in one another.

FIG. 37 shows a perspective view of a plurality of trolleys according to the embodiment shown in FIG. 35, the trolleys being in the storage configuration and being nested in one another.

FIG. 38 shows a perspective view of the measurement device according to the embodiment shown in FIG. 35.

FIG. 39 shows a perspective view of the trolley of the present invention according to a sixth embodiment. In this figure, the containers are in the extended configuration.

FIG. 40 shows a side view of the trolley according to the embodiment shown in FIG. 39.

FIG. 41 shows another perspective view of the trolley according to the embodiment shown in FIG. 39.

FIG. 42 shows a front view of the trolley according to the embodiment shown in FIG. 39.

FIG. 43 shows a perspective view of the trolley with the front abutment according to the embodiment shown in FIG. 39.

FIG. 44 shows a side view according to the sixth embodiment. In this figure, the containers are in the compressed configuration.

FIG. 45 shows a side view of the trolley according to the embodiment shown in FIG. 44.

FIG. 46 shows another perspective view of the trolley according to the embodiment shown in FIG. 44.

FIG. 47 shows a front view of the trolley according to the embodiment shown in FIG. 44.

FIG. 48 shows a sectional view of the trolley according to the embodiment shown in FIG. 39.

FIG. 49 shows a perspective view of the trolley according to the embodiment shown in FIG. 39.

FIG. 50 shows another sectional view of the trolley according to the embodiment shown in FIG. 39.

FIG. 51 shows a perspective view of a plurality of trolleys according to the embodiment shown in FIG. 41, the trolleys being in the storage configuration and being nested in one another, with the containers in the compressed configuration.

FIG. 52 shows another perspective view of a plurality of trolleys according to the embodiment shown in FIG. 41, the trolleys being in the storage configuration and being nested in one another, with the containers in the compressed configuration.

FIG. 53 shows a side view of a plurality of trolleys according to the embodiment shown in FIG. 41, the trolleys being in the storage configuration and being nested in one another, with the containers in the compressed configuration.

FIG. 54 shows another perspective view of a plurality of trolleys according to the embodiment shown in FIG. 41, the trolleys being in the storage configuration and being nested in one another, with the containers in the compressed configuration.

FIG. 55 shows a front view of a plurality of trolleys according to the embodiment shown in FIG. 41, the trolleys being in the storage configuration and being nested in one another, with the containers in the compressed configuration.

FIG. 56 shows an external view of a trolley according to another embodiment.

FIG. 57 shows a profile view of the trolley according to FIG. 56.

FIG. 58 shows an overhead view of a trolley according to FIG. 56.

FIG. 59 shows an enlargement of a part of the trolley according to FIG. 56, in particular the suspension structure, according to one embodiment of the present invention.

FIG. 60 shows an enlargement of a part of the trolley according to FIG. 56, in particular the measurement device, according to one embodiment of the present invention.

FIG. 61 shows an enlargement of a part of the trolley according to FIG. 56, in particular the force sensor, according to one embodiment of the present invention.

FIG. 62 shows two nested trolleys according to another embodiment of the present invention.

FIG. 63 shows a diagram of the nesting as viewed from above between two trolleys according to another embodiment of the present invention.

The drawings are provided by way of example and are not intended to limit the scope of the invention. They constitute diagrammatic views intended to ease the understanding of the invention and are not necessarily to the scale of practical applications.

### DETAILED DESCRIPTION

Before giving a detailed review of embodiments of the invention, optional features are set out below, which can be used in combination with or in replacement of one another:
According to one example, the trolley comprises at least one cover supported by the frame and disposed above the measurement device such that when a force, having a vertical component, is applied by a user to the cover, this vertical component is transmitted from the cover to the frame, then to the chassis and then to the ground without being transmitted to the suspension structure. This protects the force sensors from the force of a user leaning on the frame.

This mechanically isolates the measurement device from the frame.
According to a preferred example, the cover rests entirely on the frame.
According to one example, the cover is not in mechanical contact with the measurement device.
According to one example, the measurement device is suspended from the frame.
According to one example, the frame comprises at least an opening, a groove or a recess. The measurement device is disposed inside the opening. Preferably, the measurement device does not protrude beyond the opening. The integration thereof into the frame can thus be optimised. The measurement device is thus well protected. Preferably, the frame comprises two openings, each distributed on either side of a median plane of the trolley. Each arm of the frame has at least one opening.
According to one example, the frame comprises a first part and a second part, and the opening delimits the first and second parts. Thus, the opening is at the junction between the first and second parts.
According to one example, the measurement device is inserted into a portion of the frame, preferably between two parts of the frame.
According to one embodiment, each arm of the trolley comprises at least one measurement device disposed between a first part of the frame and a second part of the frame, the first part of the frame and the second part of the frame at least partially defining said arm.
According to one example, the chassis has a front part and a rear part, the front part having a first width dimension, the rear part having a second width dimension, the first width dimension being smaller than the second width dimension.
According to one example, the container has a front part and a rear part, the front part having a first width dimension, the rear part having a second width dimension, the first width dimension being greater than the second width dimension.
According to one example, the front part of the container is configured to surround at least part of the rear part of the container of another trolley in the storage configuration.
According to one example, the container comprises at least one flap disposed at the front of said container. Preferably, the flap forms a wall of the container, either entirely or partially. Preferably, said flap is rigidly connected to the container through at least one hinge element comprising at least one rotational axis, said flap is configured to selectively have a first configuration wherein the flap defines a wall of the container and a second configuration wherein the flap extends along a wall of the container, the flap is configured to be capable of moving in rotation about said rotational axis so as to selectively switch from one configuration to another. According to one non-limiting embodiment, the first configuration corresponds to a folded down configuration and the second configuration corresponds to a raised configuration.
Preferably, in the second configuration, the flap extends mainly along a horizontal plane.
According to one example, the flap is in the folded down configuration when another trolley is nested in the trolley.
According to one example, the hinge element comprises at least one return element configured to hold the flap in the raised configuration when another trolley is not nested in the trolley.
According to one example, the trolley comprises at least one additional measurement device carried at least partially by the chassis, and intended to measure at least one parameter relating to the weight of the at least one container and disposed beneath the container.
According to one example, the container is rigidly connected to the trolley, preferably individually, through one or more measurement devices.
According to one example, the suspension structure has a height dimension which decreases along a direction corresponding to the direction in which said trolley is nested in another trolley so as to allow the trolley to be at least partially nested in another trolley having a suspension structure that is identical to the suspension structure of said trolley.
According to one example, the frame has a height dimension which decreases along a direction corresponding to the direction in which said trolley is nested in another trolley so as to allow the trolley to be at least partially nested in another trolley having a suspension structure that is identical to the suspension structure of said trolley.
According to one example, the trolley comprises at least one coaxiality tab at least partially carried by the chassis, configured to engage an abutment carried by the container, the cooperation between the coaxiality tab and the abutment being intended to limit the rocking motion of said container. According to one example, the abutment is formed by an opening carried by the container. By abutting against the edges of said opening, the coaxiality tab limits the rocking motion of said container.
According to one example, the front part of the chassis is configured to nest in at least part of the rear part of the chassis of another trolley in the storage configuration.
According to an optional example, the trolley comprises a gripping device intended to be grasped by the user in order to move, preferably manually, said trolley.
According to one example, the measurement device is carried entirely by the suspension structure.
This allows a parameter relating to the weight of the at least one container intended to be suspended by the suspension structure to be measured.
According to one example, the measurement device comprises at least one force sensor for measuring the parameter relating to the weight of the at least one container and of the at least one product contained therein, said force sensor preferably comprising a strain gauge. This allows a parameter relating to the weight of the at least one container to be measured.
According to one example, the suspension structure has a plurality of receiving areas for suspending at least two and advantageously at least three containers. This allows a plurality of containers to be suspended according to the user's needs.
   i. According to one example, the cooperation of the suspension structure of said trolley with the suspension structure of said other trolley to allow said trolley to be at least partially nested in said other trolley comprises at least one of the following embodiments:
   i. the suspension structures are mounted such that they can move on the trolley. They are, for example, articulated to rotate about an axis that is, for example, horizontal. According to an alternative embodiment, they are mounted such that they can slide on the trolley. The mobility of the suspension structures means that, in the storage configuration, they do not impede the nesting of one trolley in another.
   ii. the suspension structures are shaped such that one trolley can be nested in another trolley.
According to one example, the suspension structure is articulated such that it rotates on the load-bearing structure, about an axis that is parallel to the ground, preferably horizontal. This allows the suspension structure to be raised to facilitate the nesting of the trolley with another trolley having a suspension structure that is identical to the suspension structure of said trolley. This results in a compact nesting system.
According to one example, the suspension structure is configured to have a carrying configuration and a storage configuration that is different from the carrying configuration, said carrying configuration allowing the at least one container to be suspended from the suspension structure, in particular when the trolley is being pushed, in said carrying configuration, the suspension structure being in contact with an abutment carried by the load-bearing structure preventing the suspension structure from rotating under the effect of gravity, said storage configuration being configured to allow the trolley to be at least partially nested with another trolley having a suspension structure that is identical to the suspension structure of said trolley, in the storage configuration, the suspension structure of said trolley being at a distance from the abutment.

This allows the user to choose the configuration of the trolley according to the use he/she wishes to make thereof.
According to one example, the suspension structure is configured such that, in a carrying configuration, it extends in a direction parallel to the ground.
According to one example, the suspension structure is mounted such that it can rotate freely on the load-bearing structure.

According to one example, the trolley comprises a cylinder configured to hold the suspension structure in the storage configuration at least when the suspension structure is not suspending any containers.

This makes it easier to nest the trolley with another trolley having a suspension structure that is identical to the suspension structure of said trolley. This results in a compact nesting system.
According to one example, the suspension structure is shaped so as to have an at least partially serrated top surface forming said receiving areas. This allows any handles or grips of at least one container to be suspended and held in a stable manner on the receiving areas.
According to one example, the suspension structure comprises at least one suspension bar shaped to at least partially penetrate the at least one container.

This makes it easier to position the at least one container on the suspension structure.
According to one example, the suspension structure comprises at least a first arm and a second arm extending on either side of said trolley respectively in a first direction and a second direction, the first direction and the second direction being concurrent.
According to one example, the suspension structure has a height dimension which decreases along a direction corresponding to the direction in which said trolley is nested in another trolley so as to allow the trolley to be at least partially nested in another trolley having a suspension structure that is identical to the suspension structure of said trolley.

This makes it easier to nest the trolley in another trolley having a suspension structure that is identical to the suspension structure of said trolley. This results in a compact nesting system.
According to one example, the first arm and second arm are shaped such that they each have at least two first portions, for example horizontal portions, extending in two directions parallel to the ground or having a first inclination to the ground. Moreover, the first and second arms are shaped such that they each have at least a second portion, for example a vertical portion extending in a direction orthogonal to the ground or having a second inclination to the ground, the second inclination being greater than the first inclination. The second portion separates the two first portions, so as to allow said trolley to at least partially nest with at least one other trolley having a suspension structure that is identical to the suspension structure of said trolley by nesting the suspension structure of said trolley with the suspension structure of said at least one other trolley.
According to one example, the suspension structure has a length dimension L2 and is configured to allow said length dimension L2 to be varied.

This allows the length dimension L2 to be adapted to the user's needs. Generally speaking, the lengths are measured in a direction parallel to the preferred direction of forward travel of the trolley.
According to one example, the length dimension L2 is greater than 5 cm, preferably greater than 15 cm and advantageously equal to 25 cm.
According to one example, the arms comprise telescopic portions which are each configured to have an extended configuration wherein the telescopic portions of the arms are extended and a retracted configuration wherein the telescopic portions of the arms are retracted, said retracted configuration allowing said trolley to be nested with at least one other trolley having a suspension structure that is identical to the suspension structure of said trolley.

This makes it easier to nest the trolley in another trolley having a suspension structure that is identical to the suspension structure of said trolley. This results in a compact nesting system.
According to one example, the suspension structure has a width dimension 12 which is shaped such that it decreases along a direction corresponding to the direction in which said trolley is nested in another trolley so as to allow the trolley to be at least partially nested in another trolley having an identical suspension structure.

This makes it easier to nest the trolley in another trolley having a suspension structure that is identical to the suspension structure of said trolley. This results in a compact nesting system.

Generally speaking, the widths are measured in a direction perpendicular to the preferred direction of forward travel of the trolley.
According to one example, the width dimension 12 is less than 21 cm, preferably less than 14 cm and advantageously equal to 7 cm.
According to one example, the arms of the suspension structure are rigidly connected to one another by means of at least one telescopic connecting portion, said telescopic connecting portion being configured to have an extended configuration, wherein the arms are in a distant position from one another, and a retracted configuration, wherein the arms are in a close position to one another and wherein the trolley is capable of being nested with at least one other trolley having a suspension structure that is identical to the suspension structure of said trolley.
According to one example, the trolley comprises at least one tray entirely suspended from the load-bearing structure by at least one flange, preferably by at least two flanges, advantageously opposite one another, and at least one flange comprises at least one additional device for measuring the weight of said suspended tray and of the at least one product intended to be placed therein.

This allows heavy products to be deposited and weighed.
According to one example, the suspended tray comprises at least one opening configured to at least partially receive at least the suspension bar of at least one other trolley having a suspension bar that is identical to the suspension bar of said trolley and when the trolley and the other trolley are nested with one another.

This makes it easier to nest the trolley in another trolley having a suspension structure that is identical to the suspension structure of said trolley. This results in a compact nesting system.
According to one example, the trolley comprises at least one recipient for receiving at least one product and which is supported by said chassis, the weight of which product is measured by said measurement device.

This allows heavy and bulky products to be deposited and weighed.
According to one example, the recipient has at least one side wall configured such that it can rotate about a rotational axis, preferably parallel to the ground, such that the wall can move from a configuration wherein the wall is disposed in a first position defining, with the other walls of the recipient, a closed container, into a configuration wherein said wall is disposed in a second position which is inclined relative to the first position about the rotational axis and which allows said trolley to be at least partially nested with at least one other trolley having a recipient that is identical to the recipient of said trolley.

This makes it easier to nest the trolley in another trolley having a recipient that is identical to the recipient of said trolley. This results in a compact nesting system.
According to one example, the trolley is configured such that when a force applied by a user to the gripping device has a vertical component, this vertical component is transmitted from the gripping device to the chassis and then to the ground without being transmitted to the load-bearing structure and to the suspension structure.

This allows the user to lean on the gripping device to move the trolley without interfering with the measurement of a parameter relating to the weight of the at least one container and of the at least one product contained therein.
According to one example, the trolley comprises at least one frame carried by the chassis, the frame being configured so that when a force, having a vertical component, is applied by a user to the frame, this vertical component is transmitted from the frame to the chassis and then to the ground without being transmitted to the load-bearing structure and to the suspension structure.

This allows the frame to prevent the user from accessing the suspension structure to lean thereon. The user can thus lean on the trolley, in particular on the frame, without interfering with the measurement of a parameter relating to the weight of the at least one container and of the at least one product contained therein.
According to one example, the frame is configured to define an envelope enclosing an internal volume and the receiving areas of the suspension structure are located within said internal volume.
According to one example, the frame is at a distance from the suspension structure.
According to one example, the trolley comprises at least one display device, which is configured to display the price of a product for which at least one weight-related parameter is measured by the measurement device.

This allows the user to monitor the price of the at least one product intended to be contained in the at least one container.
According to one example, the suspension structure comprises at least two containers, also referred to as boxes or trays, intended to receive the at least one container and the product contained therein.
According to one example, the suspension structure comprises at least one container having at least two receiving areas for suspending an additional container.
According to one example, the suspension structure comprises at least a first container and a second container, at least one whereof is configured to move in translation relative to the frame such that, in a retracted configuration of the trolley, the first container is at least partially housed inside the second container. This embodiment can be combined with all of the aforementioned features and technical effects.
According to one example, the trolley is configured such that the first container is entirely housed inside the second container in the retracted configuration, i.e. when the trolley is at least partially nested in the other trolley.
According to one example, the trolley is configured such that the containers take on an extended configuration, with the switch from the retracted configuration into the extended configuration taking place under gravity.
According to one example, the at least one container is mounted such that it can slide on the suspension structure so as to move in translation relative to the frame, the direction of sliding being inclined so as to cause the at least one container to move in translation under gravity.
According to one example, the trolley is configured such that the containers take on an extended configuration and the switch from the extended configuration into the retracted configuration takes place by nesting the trolley in another trolley.
According to one example, the trolley comprises at least three containers, each container being mounted such that it can slide on the suspension structure, preferably such that it can slide when the trolley is nested in another trolley and/or when the trolley is removed from its nesting with another trolley.
According to one example, the one or more containers are rigid, i.e. they cannot be deformed manually.
According to an alternative example, the container is deformable and becomes deformed when the trolley is nested in another trolley. The container is flexible or crumpable. According to one example, the container has preferred deformation areas. According to one example, the container moves from a retracted configuration into an extended configuration under gravity, at least one of the ends of the container being able to slide along the suspension structure, driven by the point thereof. According to one example, the container is at least partially made of fabric or canvas.
According to one example, the trolley comprises at least one container in which at least one product is intended to be placed.
According to one example, the at least one container is rigid, i.e. it cannot be deformed manually.
According to one example, the suspension structure, the at least one container and the chassis of said trolley are shaped so as to cooperate with the suspension structure, the at least one container and the chassis of another trolley so as to allow at least a part of said trolley to be at least partially nested in at least a part of said other trolley by cooperation between the suspension structure, the at least one container and the chassis of said trolley, and the suspension structure, the at least one container and the chassis of said other trolley.
According to one example, the suspension structure, the at least one container and the chassis of said trolley are shaped so as to cooperate with the suspension structure, the at least one container and the chassis of another trolley so as to allow at least a part of said other trolley to be at least partially nested in at least a part of said trolley by cooperation between the suspension structure, the at least one container and the chassis of said other trolley, and the suspension structure, the at least one container and the chassis of said trolley.

It should be noted that, within the scope of the present invention, the term “identical” used as in “a first element that is identical to a second element” is understood to mean that these two elements have structurally and/or functionally similar features.

In all of the embodiments described hereinbelow, the terms trays, containers, boxes or recipients are considered equivalent and can be substituted for one another.

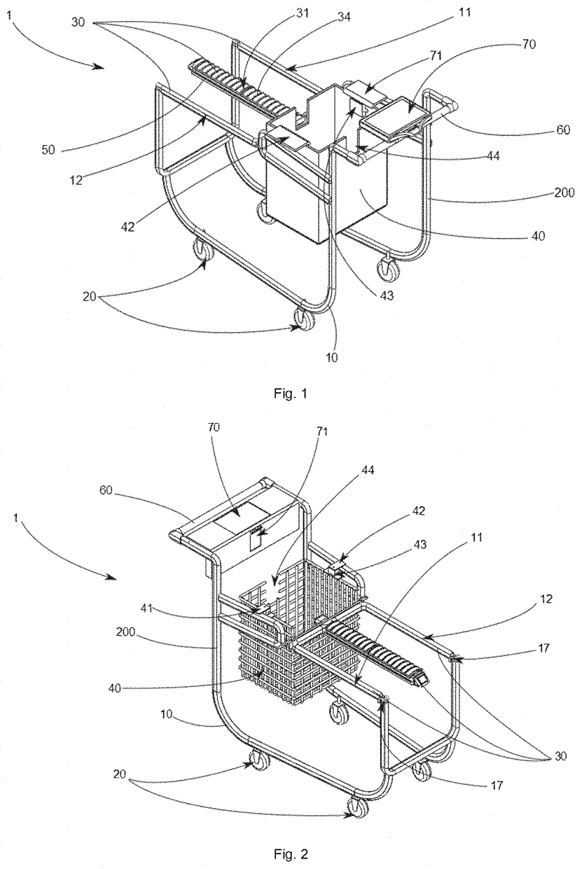

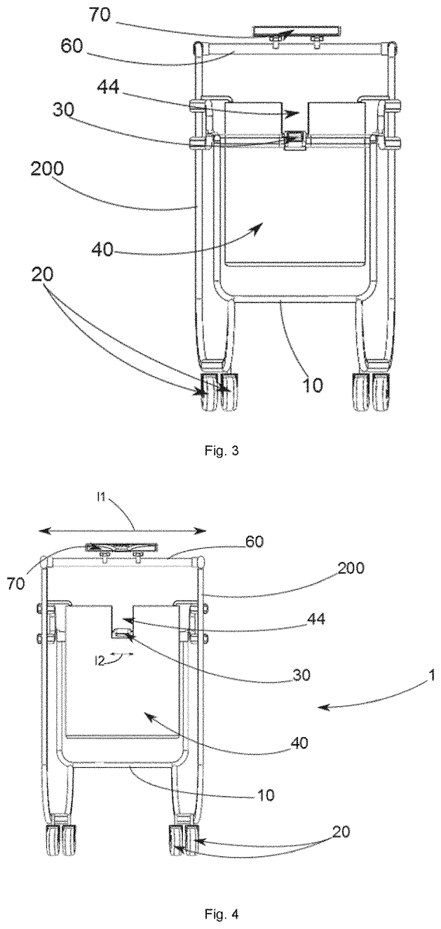

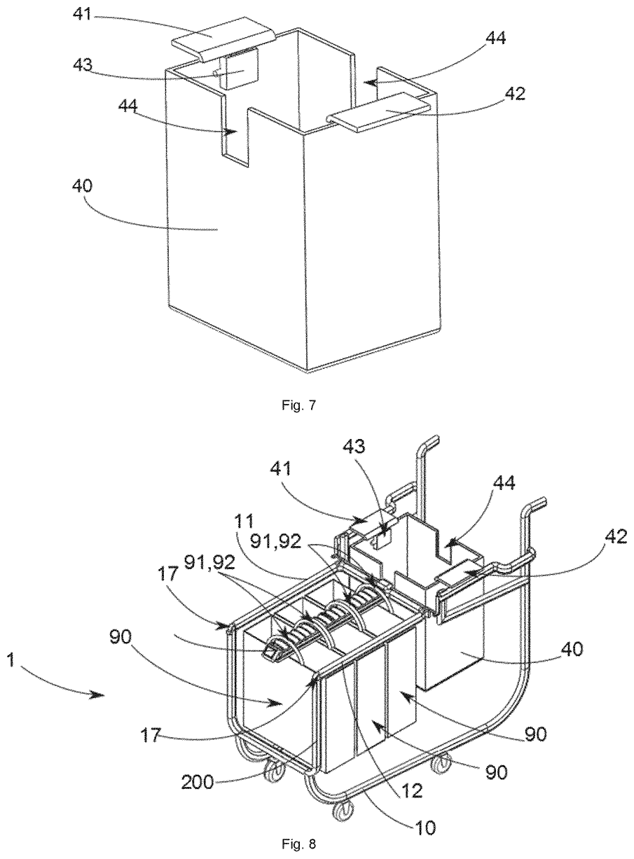

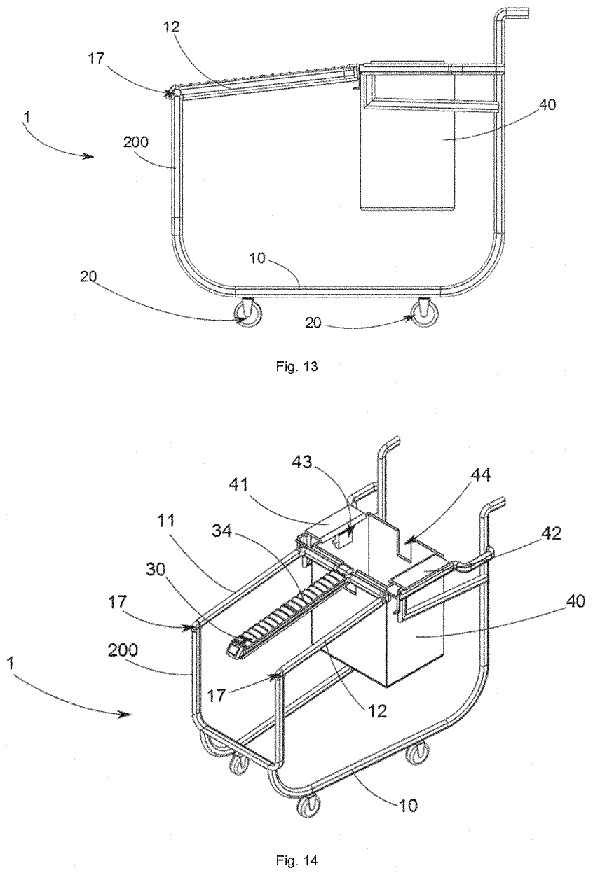

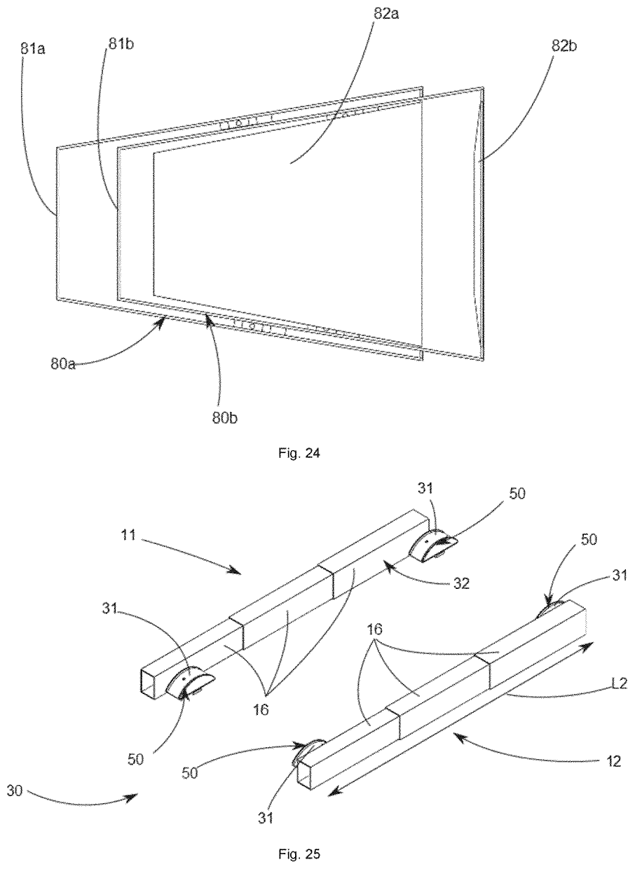

The invention will now be described in its many embodiments with reference to FIGS. 1 to 32.

The present invention relates to a trolley 1, for example for a supermarket as described hereinbelow. The trolley 1 is a transport trolley, thus enabling loads to be transported. In one non-limiting example, these loads are grocery items placed in a container.

The trolley 1 could also be used in all industrial fields requiring the transport of loads, such as the food industry or in airports for transporting luggage.

FIGS. 1 to 11 show the trolley 1, which comprises at least one measurement device 50 for measuring a parameter relating to the weight of the at least one container and of the at least one product. The at least one product is typically placed in the at least one container by the user.

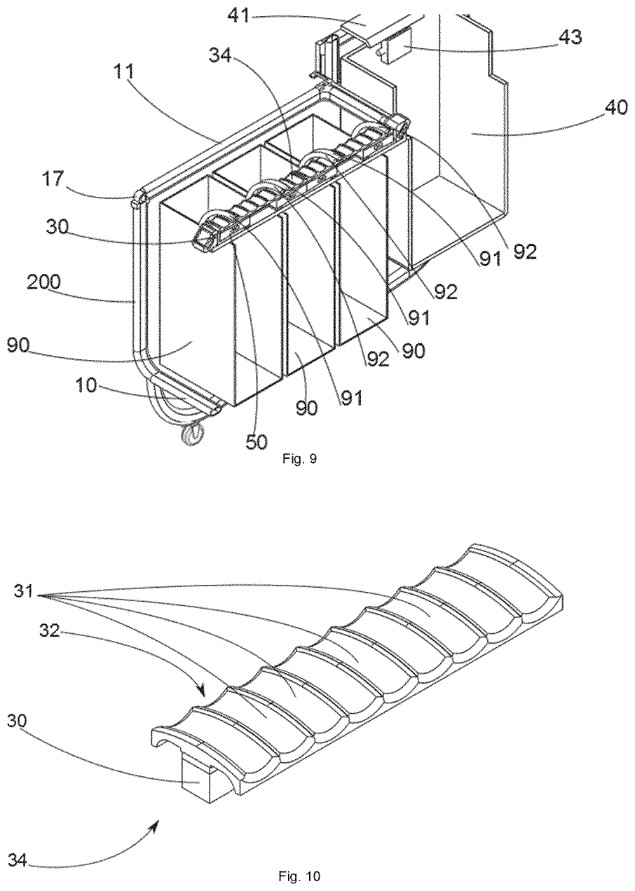

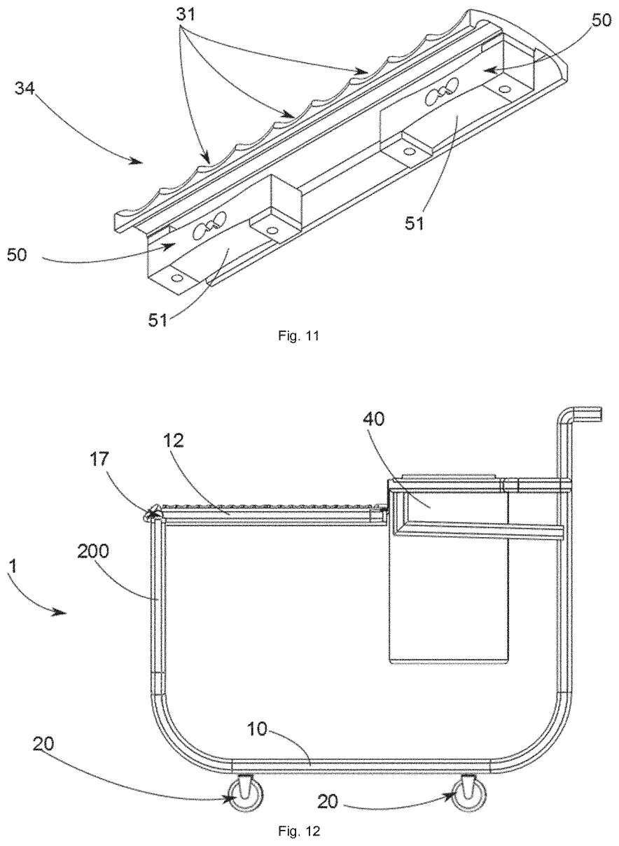

According to one embodiment, the container can be a suspended tray 40 as shown in FIGS. 1 to 9 for example. According to another embodiment that is compatible with the previous embodiment, the container can also be a bag 90 such as a plastic carrier bag, shopping bag or rigid bag as shown in FIGS. 8 and 9 for example. Generally speaking, the at least one container (40, 90) can be any element whose function is to contain the at least one product.

The measurement device 50 can comprise at least one force sensor 51, which can also be referred to as a force sensor, shown in FIG. 11 for example. The measurement device is configured to measure a parameter relating to the weight of the at least one container (40, 90) and of the at least one product contained therein. For example, the measurement device 50 can be configured to form a cantilever-type load sensor.

According to one example, the force sensor 51 comprises a strain gauge or extensometer. The force sensor 51 can be a so-called S-shaped “single-point” sensor. This enables a parameter relating to the weight of the at least one container (40, 90) and of the at least one product contained therein to be measured. In a preferred case where the at least one container (40, 90) has a negligible weight, the measurement device 50 mainly measures a parameter relating to the weight of the at least one product. In an alternative case where the at least one container (40, 90) has a non-negligible weight, the present invention provides a trolley 1 capable of subtracting the weight of the at least one container (40, 90) from the total weight measured in order to obtain only the measurement of the weight of the at least one product.

The trolley 1 comprises at least one chassis 10. The term “chassis” is understood to mean a rigid framework intended to support other elements of the trolley 1. The chassis 10 is supported by at least three bearing members 20 configured to isostatically support the trolley 1 on a ground. At least two of the at least three bearing members 20 each comprise at least one rolling device, preferably the at least three bearing members 20 comprise at least one rolling device. The rolling device preferably comprises at least one wheel. According to one example, the rolling device is a wheel. Alternatively, the rolling device is a sphere reducing the point of contact between the rolling device and the ground to increase the manoeuvrability of the trolley. According to another example, the rolling device is a track. The at least three bearing members 20 are present in all embodiments described by the invention. Moreover, the trolley 1 comprises a load-bearing structure 200 supported by the chassis 10. The term “load-bearing structure” is understood to mean any element or set of elements that performs a supporting function. For example, the load-bearing structure 200 can take on the form of a frame, vertical beams or columns.

The load-bearing structure 200 supports a suspension structure 30. The term “suspension structure” is understood to mean any element or set of elements that performs a suspension function. As a non-limiting example, the suspension structure 30 can be a bar, a platform, a hook, a handle, or a part of a frame. The suspension structure 30 has receiving areas 31. The receiving areas 31 are configured to suspend the at least one container (40, 90) in which the at least one product is intended to be placed.

Preferably, the measurement device 50 is carried by the suspension structure 30. Thus, when the at least one container (40, 90) contains the at least one product and is suspended by the suspension structure 30, the user can know the weight of the at least one container (40, 90) and of the at least one product through the measurement carried out by the measurement device 50. Preferably, the measurement device 50 carried by the suspension structure 30 can measure weights comprised between 1 g and 30 kg per sensor.

As a non-limiting example, the suspension structure 30 has a length dimension L2 configured to suspend at least one, preferably at least two and advantageously at least three containers 90.

The suspension structure 30 is thus long enough to allow the user to suspend all of the containers 90. Advantageously, it has a width dimension 12.

Moreover, the trolley 1 comprises a gripping device 60 as shown in FIGS. 1 to 4. This gripping device 60 is intended to be grasped by the user. This allows the user to manually operate the trolley 1. The gripping device 60 can take on the form of handles or a rigid bar. The trolley 1 is also advantageously configured such that when a force applied by a user to the gripping device 60 has a vertical component, this vertical component is transmitted from the gripping device 60 to the chassis 10 and then to the ground without being transmitted to the load-bearing structure 200 and to the suspension structure 30. Thus, when the user is browsing the various shelves in the supermarket, and thus has to grasp the gripping device 60 of the trolley 1 in order to move it, the force applied by the user to the trolley 1 does not interfere with the measurement.

In order to communicate the measured weight to the user, the trolley 1 can comprise at least one display device 70. The display device 70 is configured to display information of the type of at least one from among: instructions for the user, check the validation of the at least one product, list of validated products, miscellaneous information about the at least one product, price of the at least one product, or photos representing the at least one product.

Moreover, the trolley 1 comprises at least one optical scanner 71. This allows the user to read the information stored in the form of bar codes for each product before inserting it into the at least one container (40, 90) and/or placing it in the trolley 1.

According to one embodiment, the optical scanner 71 records the listed price/kg of the at least one product and the display device 70 can display the price to be paid by the user for this product based on the weight measured by the measurement device 50.

The use of an optical scanner 71 allows a price to be associated with each selected product, whether or not it is based on the weight of the product. Moreover, it prevents fraud when shopping in supermarkets. More specifically, many people are known to voluntarily not scan all selected products in order to pay less for their groceries. This weighing step in particular ensures that each product placed by the user in the trolley 1 has been scanned and thus included in the sum to be paid. More specifically, if the weight measured by the measurement device 50 of a product is different from the weight of the product read by the optical scanner by means of a bar code for example, it is thus easy to determine that different or additional products have been inserted into the trolley 1, including those not scanned beforehand by the optical scanner 71.

In a particularly advantageous manner, and in order to compensate for a time drift error of the measurement device 50, the measurement device 50 can comprise a so-called “virtual tare” performed between each insertion of the at least one product into the trolley 1. This prevents the error margin from being multiplied on each product, because once a product has been validated, the reference weight is updated and becomes the weight weighed at validation.

Although the weight of the at least one product is not displayed by the display device 70, the invention comprises a validation step, which comprises algorithms using the weight data of the at least one product. This improves the detection of fraud or the performance of statistical analyses. Furthermore, the absence of any display of the weight of the at least one product 90 on the display device 70 prevents the user from being able to easily substitute the at least one product with another product by being able to view the weight parameter on the display device 70.

The optical scanner 71 can be capable of being removed from the trolley 1 or can be fixed thereto. Advantageously, the display device 70 is carried by the gripping structure 60. This allows the user to always know the cost of his/her groceries while browsing the different shelves. The user can thus adapt his/her groceries to suit a budget as he/she goes.

A further aspect of the invention concerns the suspension structure 30, which is shaped to cooperate with the suspension structure 30 of another trolley 1 so as to allow the load-bearing structure 200 to be at least partially nested in a load-bearing structure 200 of another trolley 1. Thus, the present invention describes, through its numerous embodiments, a trolley 1 that allows a weighing step weighing the at least one container (40, 90) and the at least one product to be carried out, and that at the same time procures a very compact nesting of the trolley 1 in another trolley 1 having an identical suspension structure.

Nesting refers to the ability to insert at least part of a trolley, typically at least 10% and preferably at least 20% and preferably at least 30% of the length of a trolley into another trolley.

As a non-limiting example, the nesting distance, i.e. the length of a trolley that can be inserted into another trolley, is 300 mm. Considering trolleys with standard dimensions with an order of magnitude of 1300 mm×650 mm, 36 trolleys can be nested in 3 separate nesting rows, i.e. 12 trolleys per row within the standard dimensions of a parking space.

The preferred embodiment of the present invention will now be described.

Advantageously, the trolley 1 has a front part and a rear part. The rear part corresponds to the part of the trolley 1 comprising the gripping device 60, the front part being opposite the rear part. According to a preferred embodiment and as shown in FIGS. 12 to 18, the suspension structure 30 is articulated such that it rotates on the load-bearing structure 200, about a substantially horizontal axis. It can advantageously be tilted downwards. Alternatively, it can be tilted upwards. This rotation can be carried out by means of a hinge 17 which produces a pivot link. The hinge is advantageously mounted on the front part of the trolley 1. The suspension structure 30 has a carrying configuration and a storage configuration that is different from the carrying configuration. The carrying configuration allows the at least one container 90 to be suspended by the suspension structure 30 in the carrying configuration. In the carrying configuration, the suspension structure 30 is in contact with an abutment carried by the load-bearing structure 200 preventing rotation of the suspension structure 30 under the effect of gravity. The storage configuration allows the trolley 1 to be at least partially nested with another trolley having an identical suspension structure in the storage position, the suspension structure 30 being at a distance from the abutment.

As a non-limiting example, the suspension structure 30 is mounted such that it can rotate freely on the load-bearing structure 200. The trolley 1 has bevels, preferably with rollers, on the front part of the suspension structure 30 and on the rear part of the suspension structure 30 such that the suspension structure 30b of a second trolley 1b is configured to lift the first suspension structure 30 of the first trolley 1a to allow nesting.

As indicated hereinabove, and in a preferred manner, the suspension structure 30 is shaped so as to have a serrated top surface 32 forming said receiving areas 31 as shown in FIG. 10. This makes it easy for the user to position, for example, handles or grips 91, 92 of the at least one container 90 on the suspension structure 30. In this case, the suspension structure 30 can be configured to have at least one suspension bar 34. The suspension bar 34 thus comprises the measurement device 50 for the at least one container 90 as shown in FIG. 11. Furthermore, the suspension bar 34 is shaped to at least partially penetrate the at least one container 90, preferably to pass through the one or more handles 91, 92 for example of the at least one container 90. As a result, the suspension bar 34 has a free end.

Advantageously, the suspension bar 34 has a length dimension configured to suspend at least one, preferably at least two and advantageously at least three containers 90.

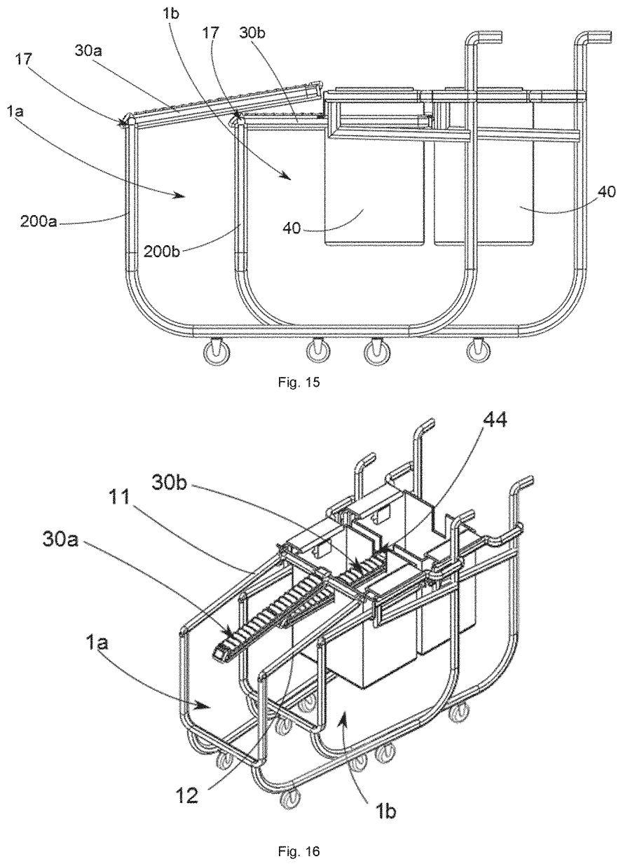

The hinge 17 is advantageously located on the front part of the trolley 1. In order to allow nesting, FIG. 15 shows that the suspension structure 30a of the first trolley 1a tilts upwards via the hinge 17 to make way for the non-tilted suspension structure 30b of a second trolley 1b.

Preferably, the at least one container 90 is removed from said trolley 1 via the front part of the trolley 1. More specifically, sliding the at least one container 90 from the receiving areas 31 towards the free end of the suspension bar 34 is sufficient to remove the at least one container 90. The user thus does not need to lift the at least one container 90 from its height to remove it from the trolley 1.

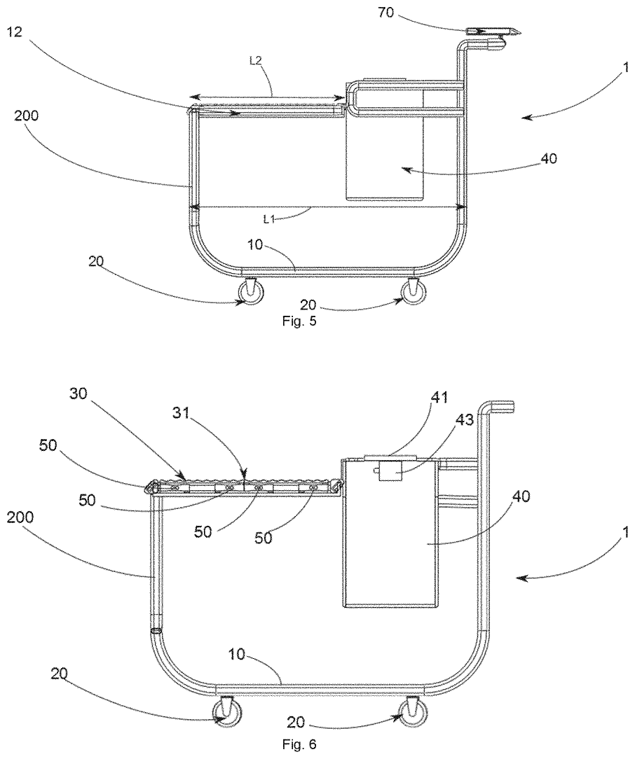

According to a preferred embodiment of the invention that is compatible with the preceding embodiment and as shown in FIGS. 1 to 8 and 12 to 18, the trolley 1 comprises at least one tray 40 fully suspended from the load-bearing structure 200. It can be seen from FIGS. 5 to 9 that the tray 40 is fully suspended advantageously by at least one flange 41 or 42, preferably by at least two flanges 41, 42, advantageously opposite one another. Each flange 41, 42 can possibly comprise at least one additional measurement device 43 for measuring the weight of said suspended tray 40 and of at least one product contained therein. Preferably the additional device 43 is an S-type sensor. Thus, the suspended tray 40 allows heavier and/or more bulky products to be contained therein such as products that cannot be placed in the at least one container 90 suspended by the suspension structure 30. The present invention thus allows a parameter relating to the weight of heavy and/or bulky products to be measured. The term “heavy” is understood to mean products weighing between 3 and 30 kg.

Moreover, the suspended tray 40 can comprise at least one opening 44 configured to receive at least the suspension bar 34 of at least one other trolley having an identical suspension bar and when the trolley 1 and the other trolley are nested with one another. This allows the trolley 1 to be nested in another trolley without the suspension bar 34 and the suspended tray 40 interfering with the nesting.

Advantageously, and as shown in FIGS. 15 and 16, the second trolley 1b can be fitted inside the first trolley 1a until the tray of the second trolley 1b almost comes into contact with the tray 40 of the first trolley 1a. According to a preferred example, when the suspension bar 34 is tilted upwards, it does not exceed the height corresponding to the gripping device 60.

The suspension bar 34 is optionally articulated such that it rotates on the trolley 1 via a hinge. According to a non-limiting example, the suspended tray 40 can be capable of being removed from the trolley 1. This facilitates nesting in the event that the suspended tray 40 does not comprise the at least one opening 44. More specifically, the user only needs to remove the suspended tray 40 to nest the trolley 1 with another trolley.

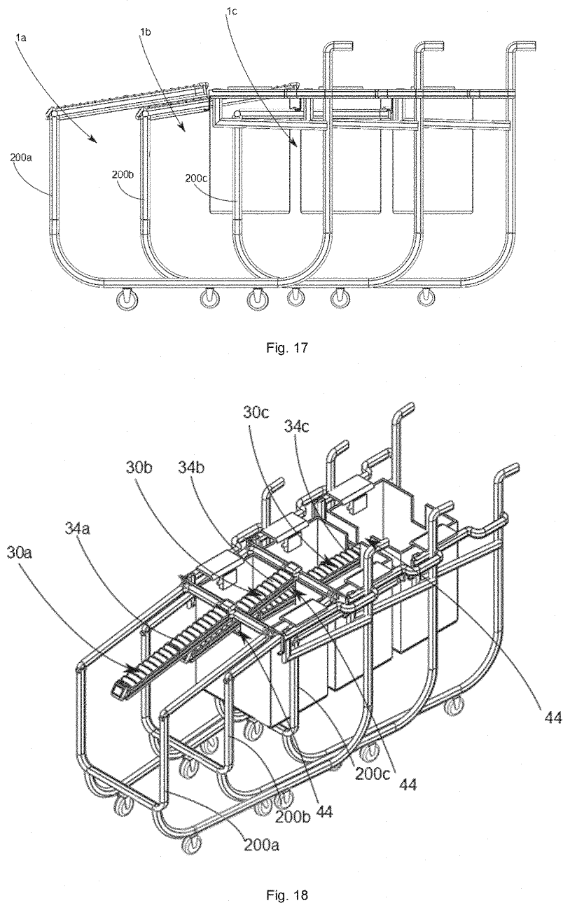

FIGS. 17 and 18 describe the nesting of the first trolley 1a with a second trolley 2a and a third trolley 3a. The nesting of the trolleys can involve a large number of trolleys.

FIG. 33 shows one embodiment wherein the suspension structure 30 is mounted such that it rotates about a horizontal axis. More specifically, the suspension structure 30 has a first arm 11 and a second arm 12 each having a proximal end that is articulated such that it rotates on the trolley 1, typically on the load-bearing structure 200. This rotational articulation can be provided by a hinge 17. The first arm 11 and the second arm 12 each have a distal end that are mechanically linked to one another by a profile. The first arm 11, the second arm 12 and the profile thus define a contour, which can be open or closed. In the carrying configuration, the first arm 11 and the second arm 12 are in contact with an abutment 19 carried by the load-bearing structure 200. This abutment 19 takes up at least part of the weight of the suspended containers 90 of the suspension structure 30. In the storage configuration, the first arm 11 and the second arm 12 are moved away from the abutment 19 in order to be raised. For this purpose, these arms 11, 12 are rotated about the axes on which they are mounted on the load-bearing structure 200. Preferably, the trolley 1 comprises at least one cylinder 18 configured to hold the suspension structure 30 in position when the suspension structure 30 is in the storage configuration, at least when the suspension structure 30 is not suspending a container 90. Typically, the cylinder 18 has one end that is articulated such that it rotates on the load-bearing structure 200 and another end that is articulated such that it rotates on one of the arms 11, 12 or on a structure rigidly connected to one of these arms 11, 12. Preferably, the trolley 1 comprises two cylinders 18, each of the cylinders being connected to one of the arms 11, 12. The suspension structure 30a of the first trolley 1a is set in the storage configuration so as to be at least partially nested with at least one second trolley 2a having an identical suspension structure 30b set in the storage configuration. For this purpose, the hinge 17 is located on the rear part of the trolley 1. In this case, the suspension structure 30a of the first trolley 1a and the suspension structure 30b of the second trolley 2b can be tilted upwards so as to allow the first trolley 1a to be nested with the second trolley 1 b. Nesting is possible until either the load-bearing structure 200a, or the suspension structure 30a of the first trolley 1a comes into contact with either the load-bearing structure 200b, or the suspension structure 30b of the second trolley 1b.

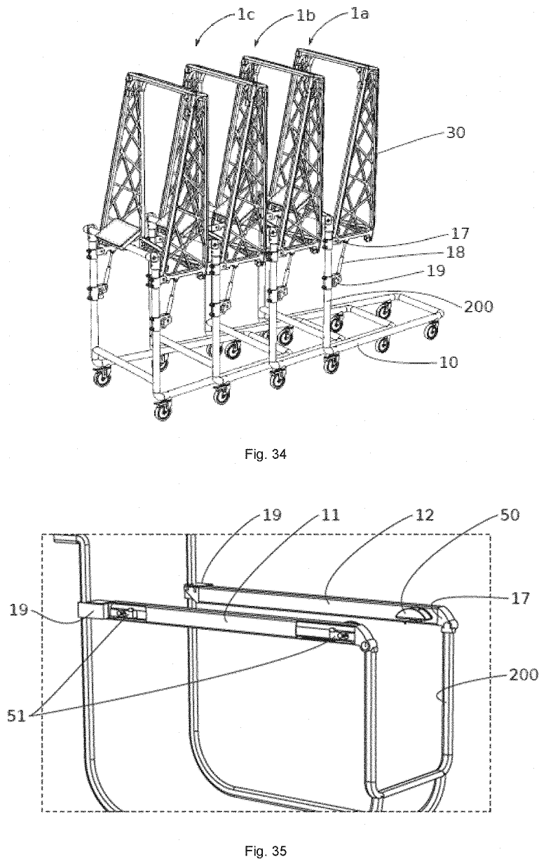

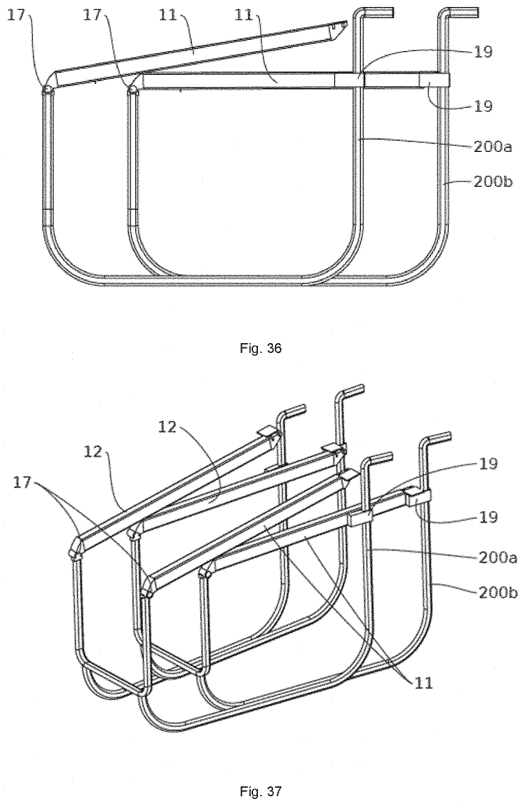

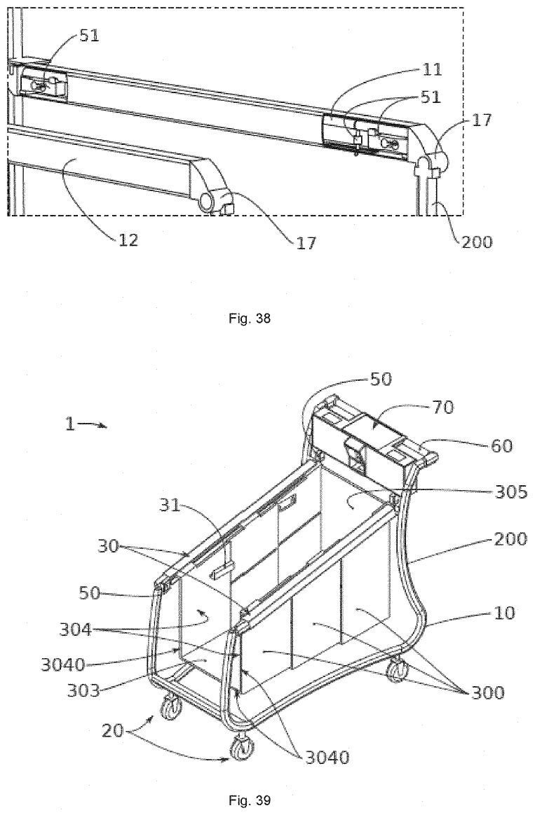

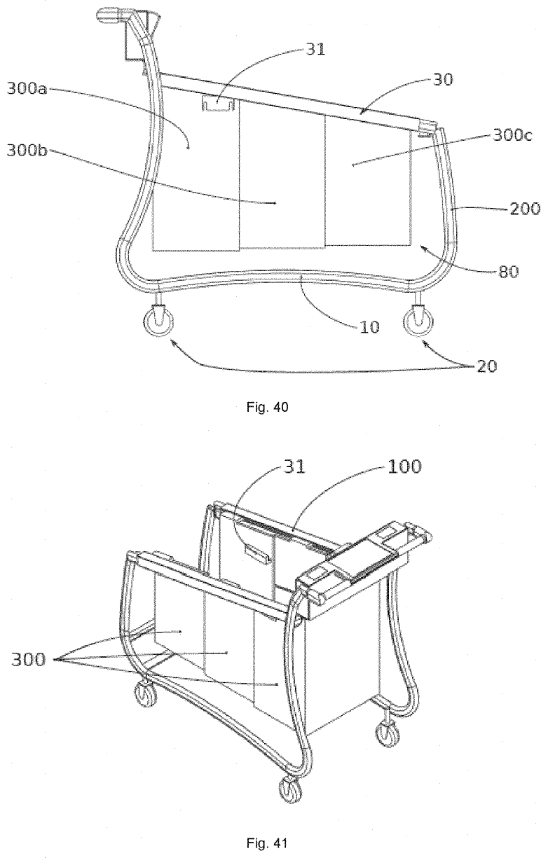

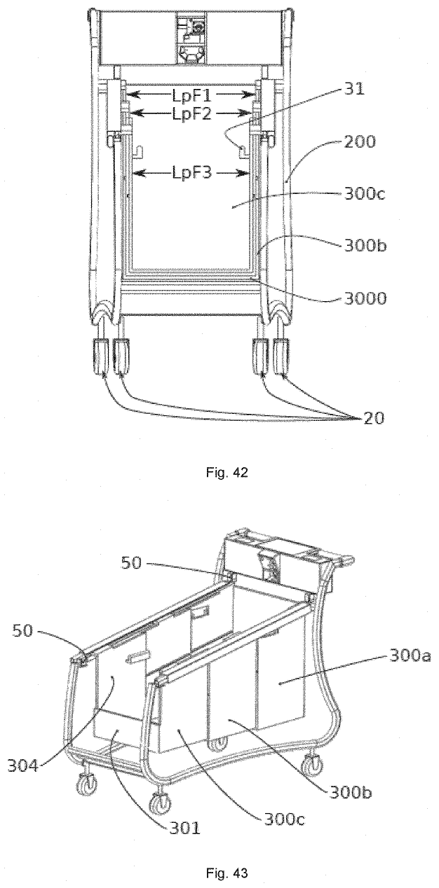

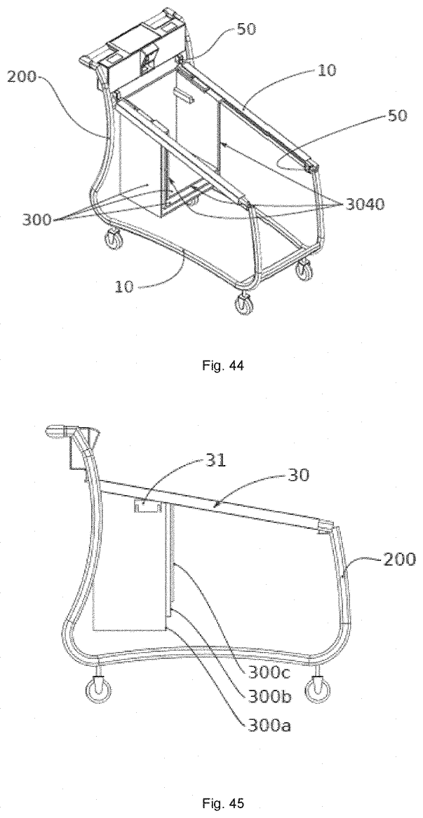

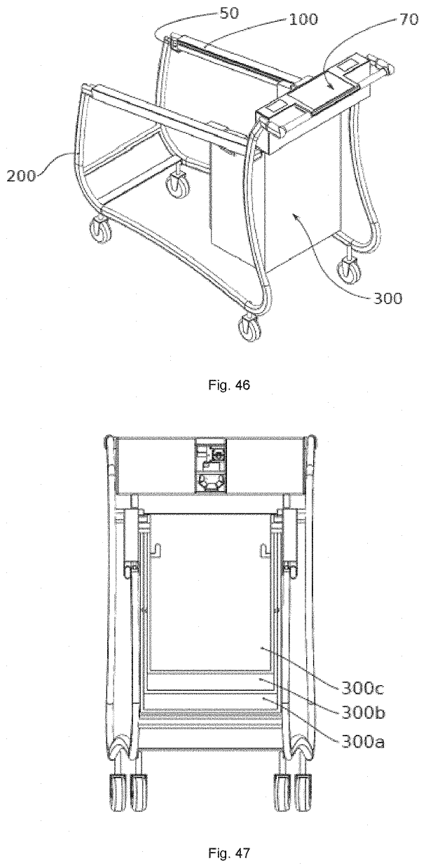

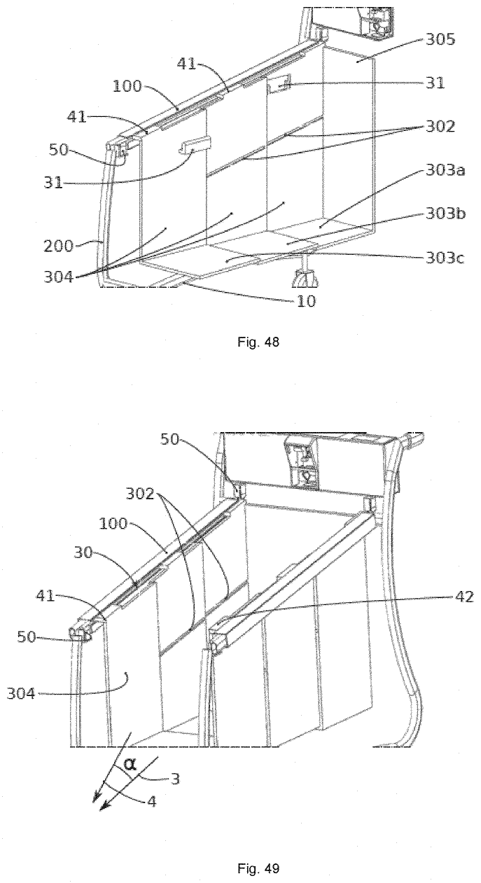

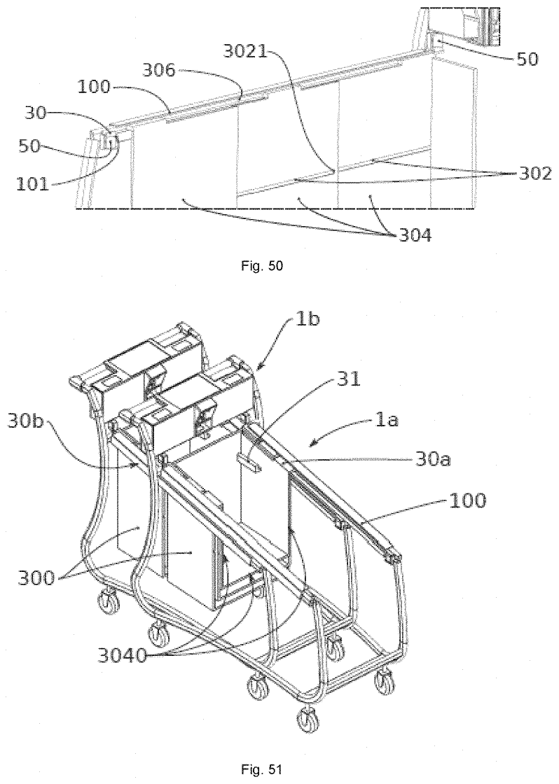

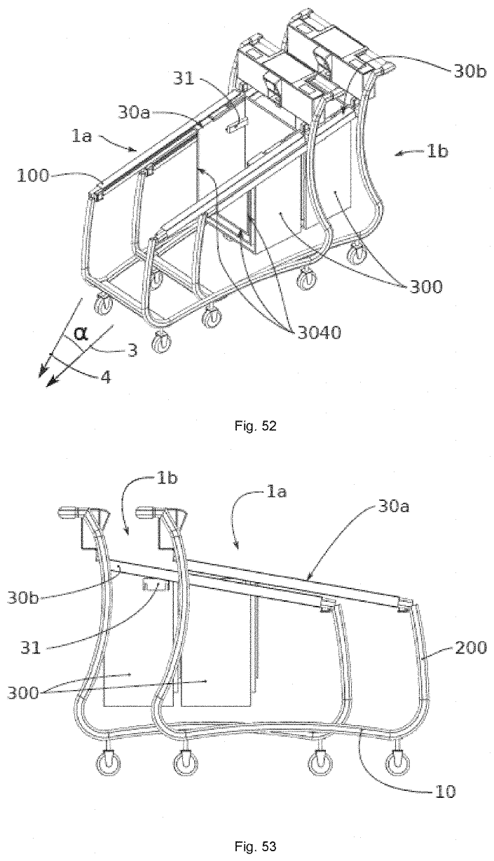

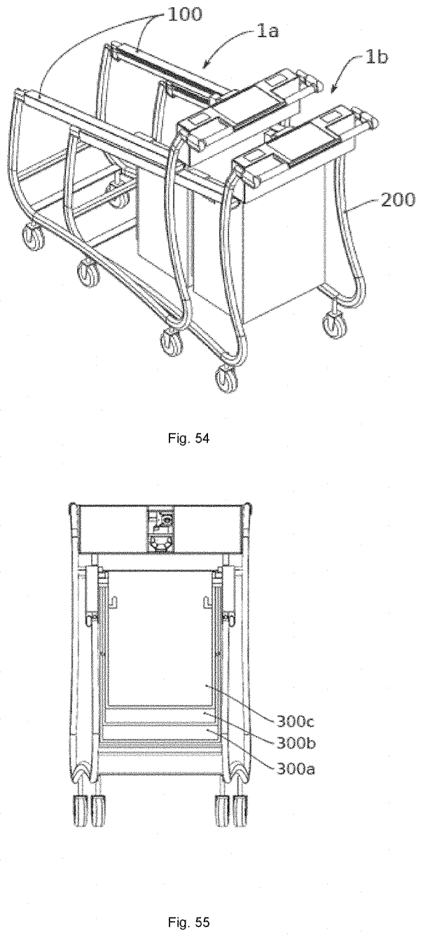

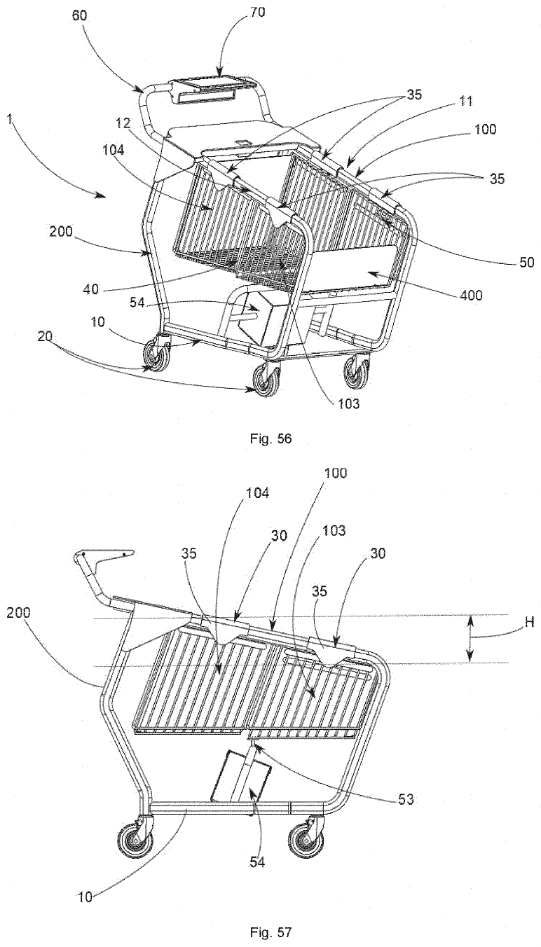

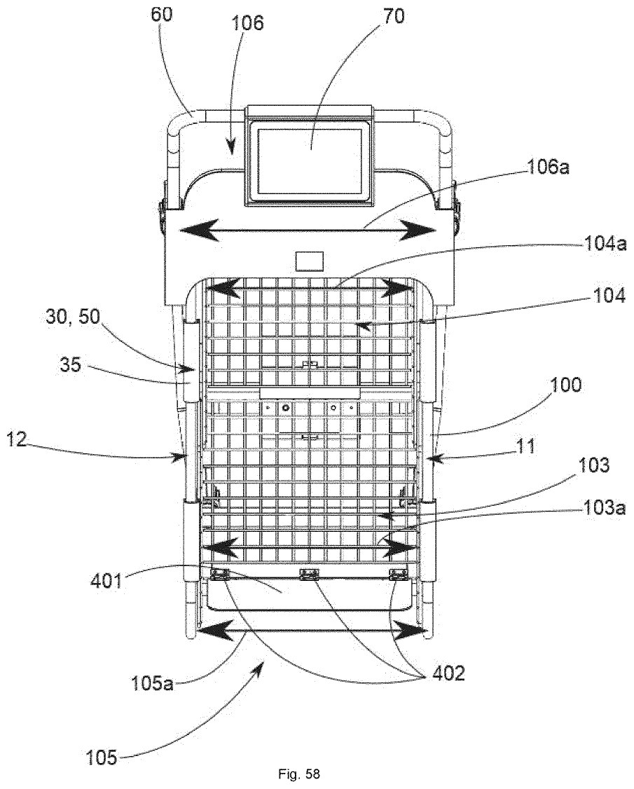

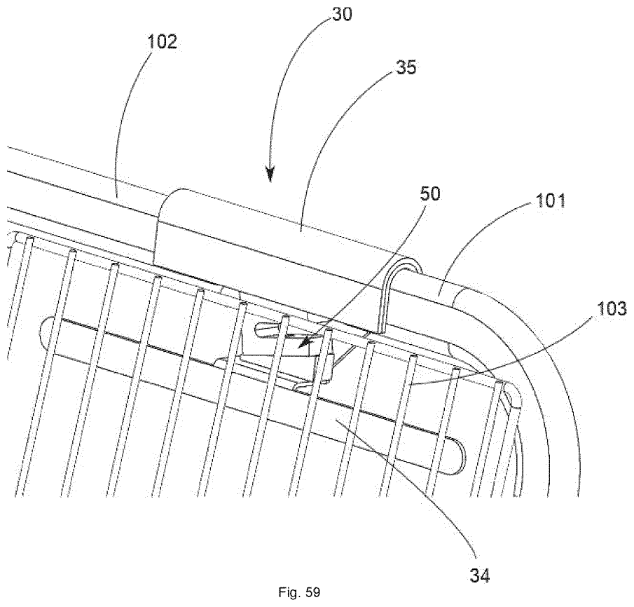

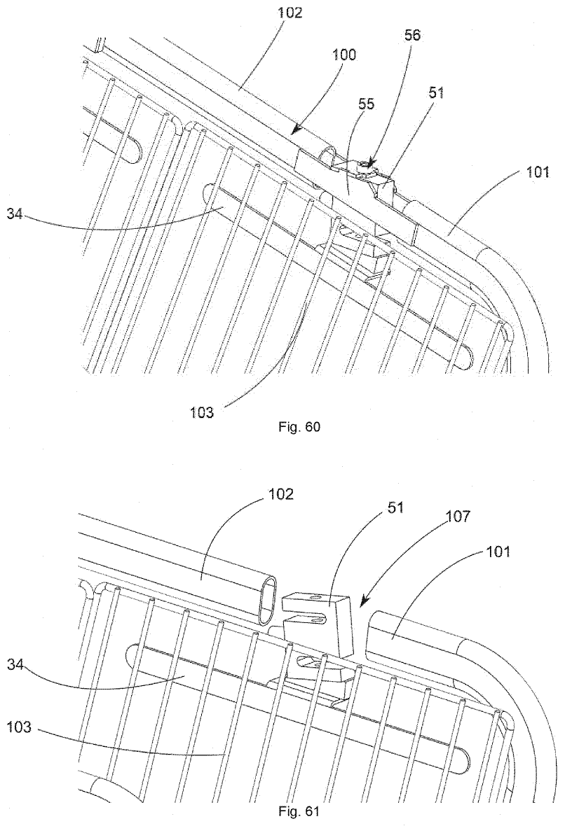

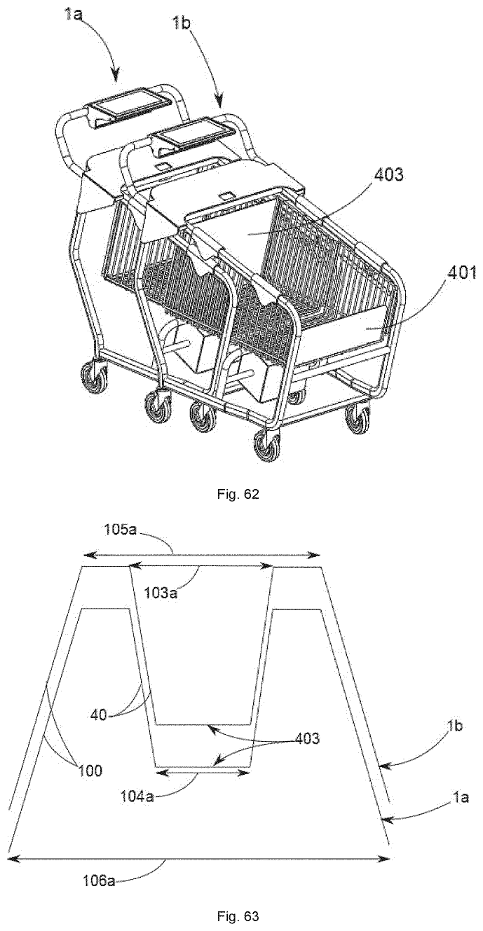

FIG. 34 shows the nesting of a plurality of trolleys 1 shown in FIG. 33. The suspension structures 30 are raised such that they are placed in the storage configuration thereof. Thus, the suspension structure 30 of a first trolley 1a does not impede the nesting of a second trolley 1b in this first trolley 1a.

This embodiment allows for a particularly high nesting rate, i.e. the nesting distance is long. This embodiment thus increases compactness when storing a plurality of trolleys 1.

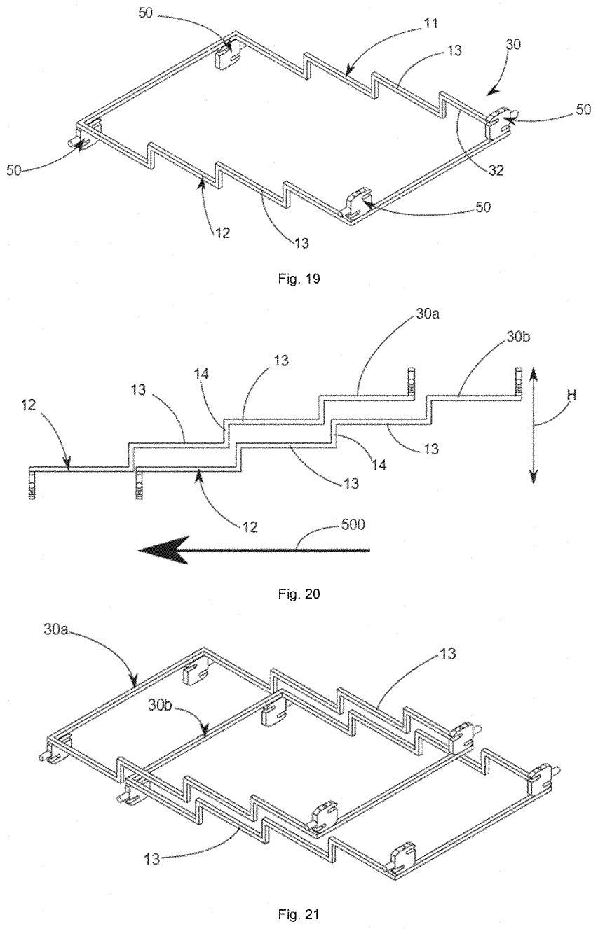

A further embodiment of the present invention compatible with the previous embodiments will now be described with reference to FIGS. 19 to 21.

According to this embodiment, the suspension structure 30 has a height dimension H that decreases along a direction corresponding to the direction of nesting 500 of the second trolley 1b in the first trolley 1a so as to allow the suspension structure 30b of the second trolley 1b to at least partially fit inside the suspension structure 30a of the first trolley 1a. In this way, the second trolley 2b can be at least partially nested in the first trolley 1a.

In a preferred case, the suspension structure 30 comprises at least a first arm 11 and a second arm 12 extending respectively in a first direction and a second direction, the first direction and the second direction being concurrent, and on either side of said trolley 1. One of either the first arm 11 or the second arm 12 thus advantageously comprises the measurement device 50.

Advantageously, the first arm 11 and the second arm 12 are shaped such that they each have at least two horizontal portions 13 and at least one vertical portion 14 separating the two horizontal portions 13, so as to form a stepped structure, for example, and thus allow said trolley 1 to be at least partially nested with at least one other trolley having an identical suspension structure by fitting the suspension structure 30a of said first trolley 1a with the suspension structure 30b of said at least one second trolley 1b, preferably by fitting the first arm 11a and the second arm 12a of said trolley 1a with the first arm 11b and the second arm 12b respectively of said at least one other trolley 2b. Preferably, the vertical portions 14 are intended to at least partially support the at least one container 90 and the at least one product. The at least one measurement device 50 is thus carried by at least one horizontal portion 13.

According to this embodiment, the nesting distance corresponds to the length of the shortest horizontal portion 13 of the first arm 11 and second arm 12 together.

Thus, the user can easily fit the trolley 1 inside another trolley 1. This nesting method allows nesting distances of around 23% of the length of a trolley 1 to be achieved. This means that at least 23% of the length of one trolley is inserted into another trolley. As a non-limiting example, the interlocking distance is of the order of 300 mm. This saves a considerable amount of space for storing trolleys when they are not in use. This thus increases the number of trolleys that can be nested in a defined space. Thus, the trolley 1 as described by the invention is not bulky. As a result, the presence of the suspension structure 30 does not interfere with the ability of said trolley 1 to be nested.

According to one embodiment shown in FIG. 21 for example, the trolley 1 comprises at least one frame 100 carried by the chassis 10. The frame 100 is shown in FIG. 31 for example.

The trolley 1 is configured such that when a force applied by a user to the frame 100 has a vertical component, this vertical component is transmitted from the frame 100 to the chassis 10 and then to the ground without being transmitted to the load-bearing structure 200 and to the suspension structure 30. This ensures that no external element interferes with the measurement carried out by the measurement device 50 for measuring the parameter relating to the weight of the at least one container 90 and of the at least one product. The term “external element” is understood to mean, for example, the pressing force applied by a person leaning on the suspension structure 30 of the trolley 1.

Thus, the presence of the frame 100 allows the user or another person to lean on said frame 100 without interfering with the measurement carried out by the measurement device 50.

In a highly advantageous manner, the frame 100 is configured to define an envelope enclosing an internal volume. Preferably, the receiving areas 31 of the suspension structure 30 are located inside said internal volume. Thus, the suspension structure 30 is advantageously not accessible for a person to lean on. This prevents any risk of interference with the measurement of the weight parameter. The measurement system is thus highly accurate and reliable.

The load-bearing structure 200 is also located inside the internal volume. To this end, the load-bearing structure 200 is not easily accessible for the user or another person to lean on.

According to an alternative example not shown in the figures, the first arm 11 and the second arm 12 are curved so as to allow the first and second arms 11b, 12b of a second trolley 1b to fit into the first and second arms 11a, 12a of the first trolley 1a.

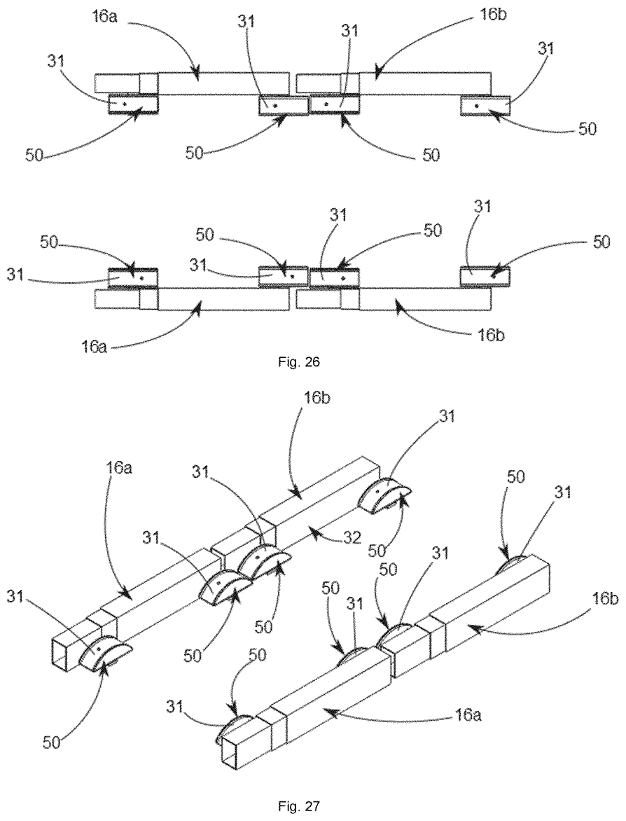

Another embodiment of the present invention will now be described with reference to FIGS. 25 to 27. As shown in FIG. 25, the suspension structure 30 is configured to allow said length L2 to be varied. More specifically, the length L2 can be varied in order to adapt the trolley 1 to the amount of groceries purchased by the user. The length L2 of the suspension structure 30 can be adjusted by the user before starting his/her shop. The user can also change the length L2 of the suspension structure 30 when the at least one container 90 has already been suspended. The suspension structure 30 can thus be reduced by at least 70% of its original length L2. This makes it easier to store the trolleys and allows a larger number of trolleys to be nested in a limited space. Preferably, the first arm 11 and the second arm 12 comprise telescopic portions 16, each of which is configured to have an extended configuration and a retracted configuration. FIG. 25 shows the extended configuration wherein said first 11 and second 12 arms are configured to at least partially support the at least one container 90 suspended from the suspension structure 30. Said first 11 and second 12 arms support in particular the at least one container 90 by the receiving areas 31 disposed on the side face 32 of the suspension structure 30. FIGS. 26 and 27 show the retracted configuration of the telescopic portions 16, wherein the first trolley 1 a is capable of being nested with at least a second trolley 1b having an identical suspension structure 30b. The telescopic portion 16a of a first trolley 1a cooperates with the telescopic portion 16b of a second trolley 1b such that at least one receiving area 31 carrying the respective measurement device 50 of each telescopic portion 16a, 16b come into contact with one another. This increases the ability of a first trolley 1a to nest with a second trolley 1b and thus increases the ability to nest a series of trolleys. Trolley storage thus occupies less space.

In this embodiment, the suspension structure 30 has at least one side face 32 such that the receiving areas 31 of the suspension structure 30 are located on the at least one side face 32. The receiving areas 31 can be handles, preferably half-moon shaped, or any abutment surface that allows the user to hang for example handles or grips of the at least one container 90. Alternatively, the receiving areas 31 are hooks, directly attached to the suspension structure 30. The force sensor 51 can be a button-type sensor directly integrated onto the receiving areas 31.

This prevents the suspension structure 30 from being weighed and allows the at least one container 90 and the at least one product to be weighed directly.

According to one embodiment not shown, the suspension bar 34 can optionally have a telescopic portion 16.

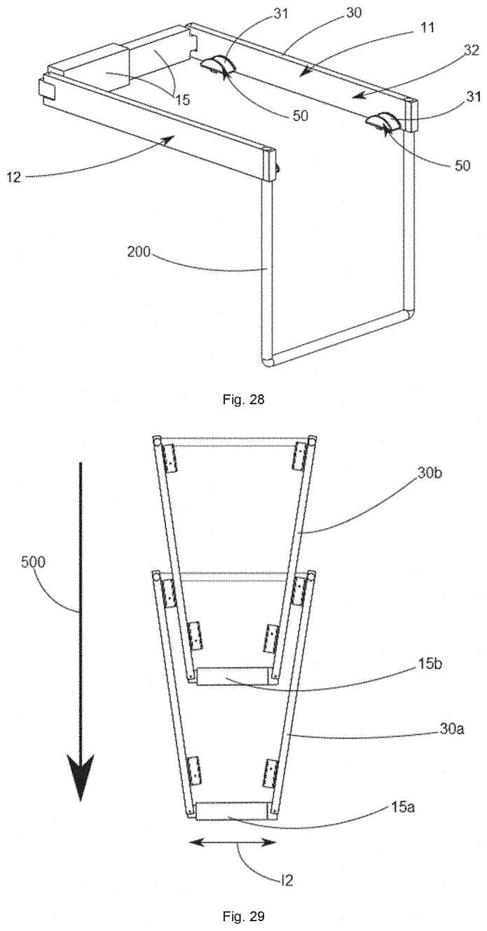

Another embodiment of the present invention will now be described with reference to FIGS. 28 to 30. According to this embodiment, the suspension structure 30 is held on the load-bearing structure 200 at the rear of the trolley 1. Moreover, the suspension structure 30 has at least one free end at the front of the trolley 1.

Advantageously, the width 12 of the suspension structure 30 is shaped such that it decreases along a direction corresponding to the direction 500 in which said trolley 1 is nested in another trolley so as to allow the trolley 1 to at least partially fit into another trolley having an identical suspension structure.

According to one preferred embodiment, the first arm 11 and the second arm 12 of the suspension structure 30 are held to the load-bearing structure 200 at the rear part of the trolley 1. Moreover, the first arm 11 and the second arm 12 are rigidly connected to one another by means of at least one telescopic connecting portion 15. The first 11 and second 12 arms are advantageously rigidly connected to one another at the free ends thereof, which are located at the front of the trolley 1. The telescopic connecting portion 15 is configured to have an extended configuration and a retracted configuration.

FIG. 28 shows the extended configuration, wherein the first arm 11 and the second arm 12 are positioned at a distance from one another. In the extended configuration, the first arm 11 and the second arm 12 are preferably parallel to one another and the telescopic connecting portion 15 is configured to be at the maximum length thereof. Said first 11 and second 12 arms support in particular the at least one container 90 through the receiving areas 31 disposed on the side face 32 of the suspension structure 30.

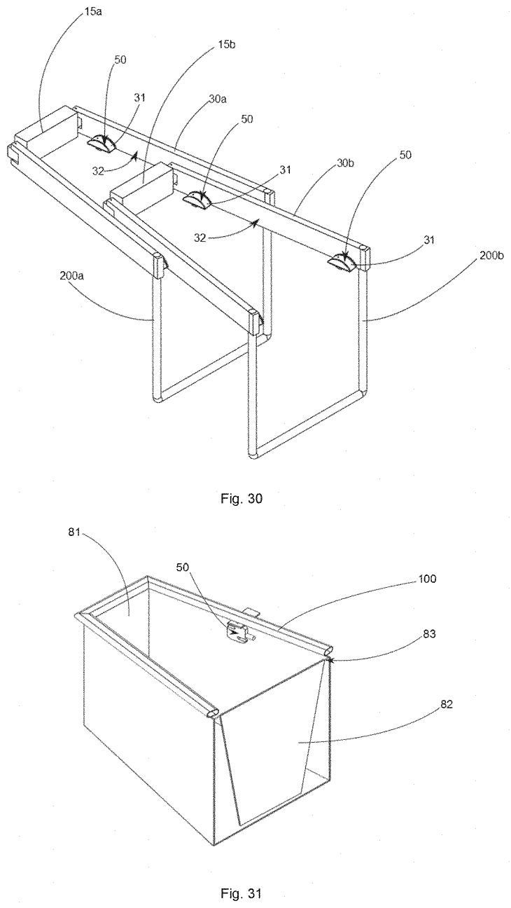

FIGS. 29 and 30 show the retracted configuration, wherein the first arm 11 and the second arm 12 are positioned close to one another. According to a more than advantageous embodiment, in the retracted configuration, the first arm 11 and the second arm 12 are concurrent with one another. More specifically, since the first 11 and second 12 arms are held to the load-bearing structure 200 at the rear of the trolley 1, when the telescopic connecting portion 15 is retracted, the first 11 and second 12 arms move towards one another at the front of the trolley 1 so as to become concurrent with one another. This allows the suspension structure 30a of the first trolley 1a to be capable of being nested with at least a second trolley 2a having an identical suspension structure 30b. For this purpose, the telescopic connecting portion 15a of the first trolley 1a and the telescopic connecting portion 15b of the second trolley 1 b are preferably each in the retracted configuration. Thus the first 11 and second 12 arms of the second trolley 1b are capable of being inserted into the first 11 and second 12 arms of the first trolley 1a.

Furthermore, there can be an infinite number of intermediate positions between the extended configuration and the retracted configuration of the telescopic connecting portion 15.

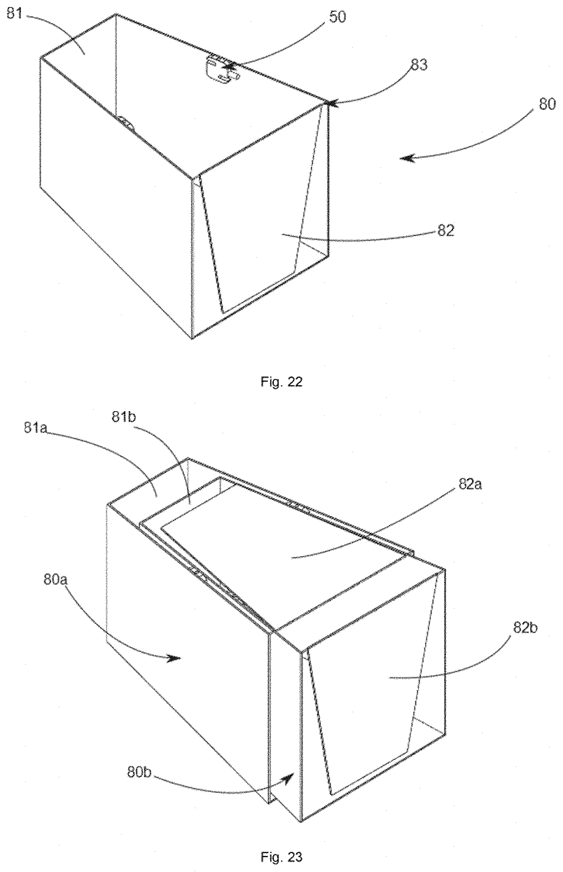

According to another embodiment and as shown in FIG. 22, the trolley 1 comprises at least one recipient 80 intended to receive at least one product. The recipient 80 is advantageously supported by the chassis 10. The parameter relating to the weight of the recipient 80 and of the at least one product contained therein is measured by the measurement device 50.

In a more than advantageous manner and as shown in FIGS. 22 to 24, the recipient 80 has at least one side wall 81 or 82 configured to be capable of moving in rotation about a rotational axis 83. The rotational axis 83 is preferably horizontal, such that the wall 81 or 82 can be moved from a configuration wherein the wall 81 or 82 forms a container with the other walls of the recipient 40, into a position wherein said trolley 1 is at least partially nested with at least another trolley having an identical recipient. According to one example of the nesting the first trolley 1a with a second trolley 1b, the recipient 80b of the second trolley 1b is inserted into the recipient 80a of the first trolley 1a in the following manner: the side wall 81b of the second trolley 2b pushes the side wall 82a of the first trolley 1a so as to cause the side wall 82a to rotate about the rotational axis 83. The recipient 80b thus penetrates the recipient 80a until the side wall 81 b comes into contact with the side wall 81a.

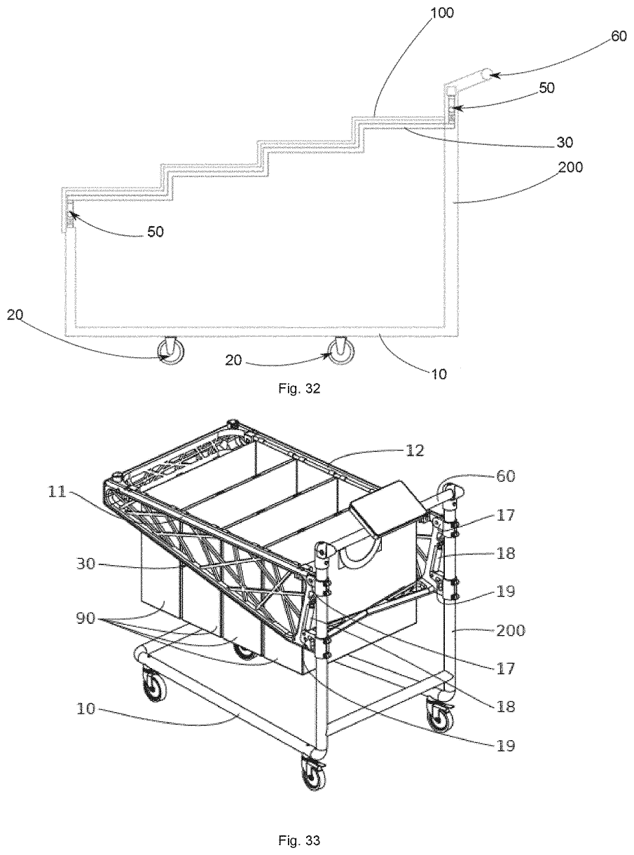

According to one embodiment shown in FIG. 32 for example, the trolley 1 comprises the at least one frame 100 carried by the chassis 10. The frame 100 advantageously closely fits around at least part of the contour of the recipient 80.

Thus, as described hereinabove, the presence of the frame 100 allows the user or another person to lean on said frame 100 without interfering with the measurement carried out by the measurement device 50.

According to another embodiment shown in FIGS. 35 to 38, the first and second arms 11, 12 of the suspension structure 30 are articulated such that they rotate on the load-bearing structure 200, about a substantially horizontal axis. The first and second arms 11, 12 can advantageously be tilted upwards. This rotation can be carried out by means of the hinge 17 which produces a pivot link along a substantially horizontal axis. The hinge 17 is advantageously mounted on the front part of the trolley 1. In the carrying configuration as shown in FIG. 35, the first arm and the second arm 11, 12 are each in contact with at least one abutment 19 carried by the load-bearing structure 200 preventing rotation of the suspension structure 30 under the effect of gravity. The storage configuration as shown in FIGS. 36 and 37 allows said first trolley 1 to be at least partially nested with another trolley 1 having an identical suspension structure in the storage position, the suspension structure 30 being at a distance from the abutment 19. Furthermore, FIG. 38 shows that the force sensor 51 can be in contact with at least one hook, which is used to suspend said containers 90. The force sensor 51 can be, for example, of the “integral load button” type. Thus, the user can directly suspend the containers 90 from the at least one hook intended for this purpose. Moreover, the first 11 and second 12 arms can advantageously comprise at least one cantilever-type force sensor 51.

According to another embodiment not shown in the figures, the rolling device 20 can comprise a device for measuring at least one parameter relating to the weight of the at least one container. This allows the entire trolley to be weighed directly, as well as the containers. Another embodiment of the present invention will now be described as it is shown in FIGS. 39 to 55. The suspension structure 30 comprises at least two containers 300, preferably three containers 300 as shown in FIGS. 39 to 44. In the description given hereinbelow, the containers may also be referred to as trays or boxes.

All of the features and all of the technical effects described in the preceding embodiments can be combined with the following embodiment, which is shown in FIGS. 39 to 55.

Advantageously, at least two containers forming adjacent trays or boxes are at least partially nestable. The containers are suspended. They can thus be considered to be configured such that they are telescopic or such that they slide into one another like Russian dolls.

Thus, in a retracted configuration, the containers are at least partially nested in pairs. At least a portion of a first container is thus housed inside a second container adjacent thereto. Preferably, the second container is located closer to the rear of the trolley than the first container. As shown in the example in FIG. 44, a single container can be provided such that it houses all or part of more than one other container. In this example, the container 300a houses the containers 300b and 300c in full.

Advantageously, the nesting of a first trolley in a second trolley causes the containers 300 of the second trolley to move and nest with one another at least in pairs. Preferably, this movement is a sliding motion. The sliding direction 4 and the normal direction of forward travel 3 of the trolley lie in the same plane. The normal direction of forward travel 3 of the trolley extends the direction of forward travel when the user pushes the trolley forward without making a turn. This direction 3 is shown in FIGS. 49 and 52.

More generally, at least one of the containers is mounted such that it can slide in the trolley and relative to at least one other container.

Each container 300 is formed by a bottom wall 303 and at least two side walls 304. The bottom wall 303 has a length dimension Lpf, which corresponds to the distance between the two side walls 304 of each container 300. The dimensions Lpf1-Lpf3 of each container are shown in FIG. 42. The two side walls 304 can be perpendicular to the bottom wall 303 and face one another. More generally, the two side walls 304 extend from the bottom wall 303 and define a “U” shape therewith, the branches whereof form a right angle or an angle greater than 90° with the bottom wall 303.

The term “wall” is understood to mean a face lying within a single plane. Each container 300 remains open and has at least one open surface, perpendicular to the side walls 304. The side walls 304 have edges 3040. For example, three of the edges 3040, form a U-shape and delimit the at least one open surface. Preferably, each container 300 has at least two open surfaces, opposite one another so that each container 300 is U-shaped. According to a highly advantageous example, the rear container 300a, i.e. the one positioned the furthest to the rear of the trolley 1, has a bottom. This back defines a third side wall 305 connecting the other two side walls 304 and thus leaving the rear container 300a with a single open surface. According to an alternative example, each container 300 has a third side wall 305.

FIGS. 48 to 50 show a detailed view of the suspension of the containers 300 from the suspension structure 30. The containers 300 are entirely suspended from the suspension structure 30, advantageously by at least one flange 41 or 42 each forming a receiving area, preferably by at least two flanges 41, 42, advantageously opposite one another. The flanges 41, 42 are not attached to the suspension structure 30, but form a slide link with the suspension structure 30. Thus, each flange 41, 42 forms a receiving area configured to fully support or suspend a container 300a-300c. For example, each flange 41, 42 forms a slider which slidably cooperates with a rail 306 of the suspension structure 30 to guide and support the container in the translation thereof relative to the trolley. The rail 306 is clearly identifiable in FIG. 50. In this manner, the containers 300 can translate along the suspension structure 30. In particular, the containers 300 translate along an axis corresponding to the direction 4 of the nesting 500 of the trolley 1.

As will be explained hereinbelow, the rail 306 is rigidly connected to or cooperates with at least one measurement device 50 such that the weight of the containers and of the items placed in the containers is transferred to the rail 306 and is detected by the measurement device 50.

Preferably, the suspension structure 30 comprises at least two rails 306, the rails 3 being disposed in parallel and carried by each side of the trolley.

The three containers 300 are advantageously disposed as follows: they are aligned in the direction 4 of the nesting 500 of the trolley 1. The rear container 300a has the largest open surface, i.e. the bottom wall 303a of the rear container 300a has the largest length dimension Lpfa. The front container 300c, i.e. that positioned the furthest towards the front of the trolley 1 has the smallest open surface, i.e. the bottom wall 303c of the front container 300c has the smallest length dimension Lpfc. Finally, the intermediate container 300b, i.e. that positioned between the front container 300c and the rear container 300a, has an open surface comprised between the open surface of the front container 300c and the open surface of the rear container 300a, i.e. the bottom wall 303b of the intermediate container 300b has a length dimension Lpfb comprised between Lpfa and Lpfc. This allows the intermediate container 300b to be nested in the rear container 300a, and the front container 300c to be nested in the intermediate container 300b as shown in FIGS. 45 to 47; the containers 300 are thus in a so-called compressed configuration. Each container 300 located inside another container 300 will be referred to as a “nesting container” and each container 300 containing another container 300 will be referred to as a “nested container”.

In a particularly advantageous manner, the direction 4 in which the containers slide is inclined relative to the horizontal. Thus, the direction 4 in which the containers slide and the horizontal, i.e. the direction of forward travel 3 of the trolley on a flat ground, jointly define an angle alpha. This angle is shown in FIGS. 49 and 50. This direction 4 is inclined forward.

The end of the rail 306 nearest the front of the trolley is closer to the ground than the end of the rail nearest the rear of the trolley. This inclination, together with the load-bearing structure 30, are configured such that the containers 300 slide forward on the trolley under the effect of gravity. Thus, when the containers are empty or are supporting items, the weight thereof pulls them towards the front of the trolley and causes them to extend, i.e. to move away from one another. Each side wall 304, 305 and bottom wall 303 of each container 300 has an inner surface and an outer surface. According to a more than advantageous embodiment, there is a gap between the outer surface of the side walls 304 of the nesting container and the inner surface of the side walls 304 of the nested container. This gap can be comprised between 0 and 50 mm. Similarly, there is a gap between the outer surface of the bottom wall 303 of the nesting container and the inner surface of the bottom wall 303 of the nested container. This gap can be comprised between 0 and 50 mm.

Furthermore, FIGS. 49 and 50 show the positioning of the measurement device 50 which is carried by the suspension structure 30 in the same way as in the embodiment shown in FIG. 19.

Furthermore, according to an optional, but preferred embodiment, it should be noted that at least one container and preferably the intermediate container 300b and the rear container 300a each have at least one guide rail 302, preferably two rails. Each rail 302 is intended to facilitate the guiding of the nesting container into the nested container. It also acts to stabilise the configuration of the containers 300. The rails are preferably disposed on the inner surface of the side walls 304 of the containers 300, preferably halfway along the height of the containers 300. More generally, it is the nested container that has the rail 302. The rail 302 is directed in the direction 4 of the nesting 500 of the containers 300. Another advantage of the rail 302 is that it allows for better weight distribution. More specifically, as a non-limiting example, the rail 302 carried by the intermediate container 300b moves in translation on the rail 302 carried by the rear container 300a. Thus, the rail 302 carried by the intermediate container 300b bears on the rail 302 carried by the rear container 300a. The rail 302 carried by the rear container 300a thus supports at least part of the weight supported by the intermediate container 300b. The weight is thus better distributed between the intermediate container 300b and the rear container 300a. This makes it easier for the user to handle the trolley 1 when shopping.

Also advantageously, these rails 302 or slides have an abutment 3021 at at least one of the ends thereof. This abutment is, for example, formed by the end of a groove or slot that defines the rail 302 and is formed in the inside face of the container. When a slider of the container that cooperates with the container carrying the rail 302 reaches the abutment 3021, the slider is stopped and the container is blocked. This makes it particularly easy to guide the translation of the containers together and control the length of travel thereof.

Thus, under the effect of gravity, the containers tend to move in translation towards the front of the trolley. The translation thereof is interrupted when one container abuts against the container adjacent thereto. One of the containers thus continues its journey while the translation of the other container is stopped. This allows the containers to be extended under the effect of gravity. The advantage of this embodiment is that no user action or actuator is required to extend the containers. The trolley in this embodiment is thus particularly easy to use, reliable and robust. As will be described in detail hereinbelow, in order to retract the containers, i.e. to at least partially nest them in one another, the user must merely at least partially nest a first trolley in a second trolley. An abutment carried by the second trolley comes into contact with the container of the first trolley located the closest to the front thereof and thus causes this front container to slide along the rail 306 (i.e. in the sliding direction 4) towards the rear of the first trolley. This front container moves until it comes into contact with the container adjacent thereto and in turn causes the latter to slide towards the rear of the first trolley. The containers can thus be retracted in a telescopic manner. As will be seen hereinbelow, this abutment carried by the second trolley can be a back wall of the container of the second trolley located the closest to the rear thereof. Alternatively, this abutment can be carried by another element of the second trolley. According to a particularly advantageous embodiment, the container disposed the closest to the rear is configured to move towards the rear of the trolley when a force is applied thereto, typically when the trolley is nested in another trolley. When the force is no longer applied to this container, this container returns to the rest position thereof under gravity alone. This backward movement has a length of travel preferably comprised between 5 and 30 centimetres. It further improves the extent to which two trolleys can be nested in one another.

The embodiment described in FIGS. 39 to 55 thus has two possible configurations for the containers 300: a so-called extended configuration shown in FIGS. 39 to 44 and a so-called retracted configuration shown in FIGS. 45 to 47.

The extended configuration is the configuration that will be preferred by the user when shopping. More specifically, this is the configuration that provides a large volume in which all of the additional containers 90, such as a bag or sachet, can be disposed. The at least one additional container 90 can be suspended from the receiving areas 31 located on the inner surface of the side walls 304 of the containers 300. However, another possible option for the user is to directly place the at least one additional container 90 or directly place the product on the back wall 305 i.e. the back wall of the rear container 300a of the first trolley 1a. In order to dispose the at least one additional container 90 in the containers 300, the invention has the advantage of providing an opening in the front container 300c, which opening corresponds to the open surface described hereinabove. This allows the user to pass the at least one additional container 90 or the product directly through this opening without having to lift the at least one additional container 90 or the product from a height equal to the height of the suspension structure 30. The user thus does not need to lift the at least one additional container 90 from its height to remove it from the trolley 1 or place it in the trolley 1. In this way, the user is spared the need to exert too much physical effort which could cause fatigue or even injury. In this configuration, it is the containers 300 that form the recipient 80 described hereinabove and shown in FIG. 22.

Optionally, the front container 300c has a front abutment 301 as shown in FIG. 44. This retains the at least one additional container 90 or the products disposed on the bottom wall 303 inside the internal volume. More specifically, if the user is required to dispose rolling products or to push the trolley 1 on sloping ground, the ability to retain the at least one additional container 90 and/or the products is highly advantageous, thus preventing them from falling from the trolley and becoming damaged.

Advantageously, when nesting a first trolley in a second trolley, the front abutment 301 of the first trolley, or the edge thereof if no abutment 301 is present, comes into contact with the back wall 305 of the second trolley. This back wall 305 acts as an abutment to stop the movement of the abutment 301 and of the container 300c. As the first trolley continues to nest in the second trolley, this abutment causes the containers of the first trolley to slide relative to one another and to nest telescopically or in a “Russian doll”-like manner inside one another. This is shown in FIGS. 51 to 54 for example. In these figures, the containers of the second trolley are shown nested in one another to make this embodiment easy to understand. It goes without saying that this configuration of containers will be possible if the second trolley is itself nested in the third trolley (or if the user pushes the containers towards the rear of the trolley, which is not a normal way of using the trolley).

This embodiment of retracting or nesting the trolleys is particularly simple since it takes place automatically when the user nests one trolley in another. Furthermore, this embodiment does not require any actuator. It is thus particularly easy to use and robust.

According to a non-limiting example, the front abutment 301 is parallel to the third side wall 305 of the rear container 300a. According to a non-limiting example, it extends perpendicularly to the two side walls 304 of the front container 300c and connects the two side walls 304 of the front container 300c. The abutment 301 has a height dimension that is less than half the height dimension of the front container 300c.

The retracted configuration is the configuration that will be preferred by the user to store the trolley 1. More specifically, as shown in FIGS. 51 to 55, when the front container 300c and the intermediate container 300b are nested in the rear container 300a, the volume occupied by all of the containers 300 is substantially three times smaller than when the trolley 1 is in the extended configuration. This saves a considerable amount of space when storing the trolley 1. Considering trolleys with standard dimensions with an order of magnitude of 1300 mm×650 mm, 36 trolleys can be nested in 3 separate nesting rows, i.e. 12 trolleys per row, in the standard dimensions of a parking space.

FIG. 53 shows that the nesting of the second trolley 1b in the first trolley 1a is possible until the third side wall 305 of the rear container 300a of the first trolley 1a comes into contact with the open surface formed by the rear container 300a of the second trolley 1b, at which point the nesting is stopped by the three edges 3040 of the opposite side walls 304 of the rear container 300a of the second trolley 1b.

Furthermore, FIGS. 53 and 54 show that, in this embodiment, the suspension structure 30 also has a height dimension H that decreases along a direction corresponding to the direction of nesting 500 of the second trolley 1b in the first trolley 1a so as to allow the suspension structure 30b of the second trolley 1b to be at least partially nested in the suspension structure 30a of the first trolley 1a. In this way, the second trolley 1b can be at least partially nested in the first trolley 1a. Nesting is thus advantageously stopped when the suspension structure 30 of the first trolley 1a and the suspension structure 30 of the second trolley 1 b rub against one another sufficiently and thus brake the nesting motion until the second trolley 1 b comes to a standstill.

As mentioned hereinabove, the trolley is intended to be configured such that the container located to closest to the rear of the trolley can slide along the rail 306 when a force is applied thereto, typically when the trolley is nested in another trolley. This further reduces the volume occupied by a plurality of nested trolleys.

Said frame 100 can also be present in the embodiment shown in FIGS. 39 to 55. Thus, as described hereinabove, the presence of the frame 100 allows the user or another person to lean on said frame 100 without interfering with the measurement carried out by the measurement device 50. In FIGS. 48 and 49 for example, it is clear that the suspension structure 30 is separate from the frame 100. In a particularly advantageous manner, the frame 100 has a shape that conceals the suspension structure 30, typically the rail 306 from the user. The latter thus cannot or cannot easily access the suspension structure, typically the rail 306, for example, to lean thereon. The user, on the other hand, will come into contact with and lean on the frame 100.

In this example, the suspension structure 30 forms a rail 306 that extends beneath a profile of the frame 100. Preferably, this profile of the frame 100 forms an inverted or inclined “U” shape or “L” shape and is open towards the inside of the trolley. Preferably, and as shown in the figures, this profile of the frame 100 forms a tube whose cross-section defines a closed contour 101 except for an opening 102, which extends longitudinally and which is configured to provide a mechanical connection between the containers and the guide rail. Typically, this opening 102 forms a slot which extends along all or part of the length of the profile of the frame 100 and which allows at least one flange 41, 42 for each container to pass. The contour 101 and the opening 102 are shown in FIG. 50. The rail 306 of the suspension structure 30 is housed inside the profile of the frame 100.

This allows a volume inside the profile to be delimited, which volume is not accessible or not easily accessible from outside the trolley. Preferably, the rail 306 of the suspension structure 30 extends along this volume. This rail 306 is thus protected. At the very least, a user cannot lean on this suspension structure 30. This prevents the weight of the items contained in the trolley from being measured incorrectly. This thus overcomes the problem of improving the reliability and accuracy of the measurement measuring the weight of the items contained in the trolley. Moreover, this improves the safety of the trolley by preventing a user from interfering with the sliders on the rail 306, for example by trapping their fingers therein. Thus, all of the embodiments describe a suspension structure configured to allow the trolley to be nested in another trolley having an identical suspension structure.

In the examples described hereinabove with reference to FIGS. 39 to 63 the containers are delimited by solid walls, that are for example made of metal or plastic. According to another embodiment, only one, a plurality, or all of the walls are formed by a mesh structure or by an openwork structure as shown in FIG. 2.

In all of the examples shown hereinabove, the containers or containers are rigid. They cannot be manually deformed. According to another embodiment, not shown, the plurality of containers or containers is replaced by a single deformable container or container. According to one example embodiment, this deformable container is made at least partially of fabric, and preferably entirely of fabric. It is configured to be compressed to selectively move from an extended configuration into a retracted configuration. In the extended configuration, it provides a first volume for receiving items deposited by the user. In the retracted configuration, it does not allow items to be deposited therein or has a smaller receiving volume than in the extended configuration.

The switch from the extended configuration into the retracted configuration is carried out by nesting the trolley in another trolley. This can be achieved by bringing a front part of the fabric container into contact with the other trolley and deforming the container. For this purpose, the fabric container can be provided with preferred areas of deformation. These preferred areas of deformation can, for example, comprise preformed areas configured to facilitate deformation.

These can be, for example, fabric, elastomer or rubber gussets.

The switch from the retracted configuration into the extended configuration preferably takes place under gravity. For this purpose, the deformable container can have flanges provided with rings or eyelets which cooperate with a guide element such as a guide rail, rod or cable, such as the rail 306 shown in FIG. 50 for example. Preferably, this guide element is inclined relative to the horizontal and approaches the ground as it extends towards the front of the trolley.

Thus, as in the embodiment shown in FIGS. 39 to 55, the front part of the deformable container moves under gravity towards the front of the trolley. For this purpose, the front part of the deformable container can be sufficiently weighted.

According to one particularly advantageous embodiment, a trolley having the same frame 100 and the same suspension structure 30 can accommodate different types of containers. Thus, one or more fixed rigid containers, one or more sliding and telescopic rigid containers, or one or more deformable containers can be selectively mounted on the same trolley.

Another preferred embodiment of the present invention will now be described with reference to FIGS. 56 to 63.

According to the embodiment shown in FIG. 56, the trolley 1 advantageously has a container 40 and preferably a single container 40. This container 40 comprises a front part 103 and a rear part 104. The rear part 104 corresponds to the part of the container 40 that is the closest to the gripping device 60, the front part 103 being opposite the rear part 104. As shown hereinbelow, the chassis 10 further comprises a front part 105 and a rear part 106. The rear part 106 corresponds to the part of the chassis that is the closest to the gripping device 60, the front part 105 being opposite the rear part 106.

According to this embodiment, the front part 103 of the container 40 has a width dimension 103a greater than the width dimension 104a of the rear part 104 of the container 40.

According to this embodiment, the front part 105 of the chassis 10 has a width dimension 105a smaller than the width dimension 106a of the rear part 106 of the chassis 10.

More specifically, according to a preferred embodiment and as shown in FIGS. 62 and 63, the trolley 1 is configured to receive at least part of another trolley 1b in the storage configuration and advantageously to be received at least in part by the other trolley 1b.

More specifically, according to this embodiment, the front part 103 of the container 40 is wider in order to be able to pass either side of the rear part 104 of the container 40 of another trolley 1b in the storage configuration. Also preferably, the front part 105 of the chassis 10 is narrower in order to be able to enter the rear part 106 of the chassis 10 of another trolley 1b in the storage configuration. Thus, it is the container 40 of the front trolley 1 b that enters the container 40 of the rear trolley 1a. As will be seen hereinbelow, for the same rear trolley 1a and front trolley 1b, when they are respectively nested, i.e. in the storage configuration, it is the chassis 10 of the rear trolley 1a that enters the chassis 10 of the front trolley 1b.

According to one embodiment, for these rear 1a and front 1b trolleys, when they are respectively nested, it is the frame 100 of the rear trolley 1a that enters the frame 100 of the front trolley 1b. Advantageously, the trolley 1a of the present invention is configured to have a part that nests in a part of another trolley 1b and to have another part that surrounds another part of another trolley 1b.

According to one embodiment, the suspension structure 30 comprises at least one suspension bar 34, at least one measurement device 50 comprising at least one force sensor 51, and at least one attachment 56 for attaching the measurement device 50 to the frame 100, and preferably the frame 100.

According to one embodiment, the suspension structure 30 has a height dimension H which decreases along a direction corresponding to the direction in which said trolley 1 is nested in another trolley 1b so as to allow the trolley 1 to be at least partially nested in another trolley 1b having a suspension structure 30 that is identical to the suspension structure of said trolley 30.

According to one embodiment, the frame 100 has a height dimension which decreases along a direction corresponding to the direction in which said trolley 1 is nested in another trolley 1b so as to allow the trolley 1 to be at least partially nested in another trolley 1b having a suspension structure that is identical to the suspension structure of said trolley 1.

According to one preferred embodiment, the measurement device 50 is inserted into the frame 100, and is preferably disposed between two parts of the frame 100. Advantageously, the frame 100 can comprise a plurality of parts 101, 102. Preferably, one or more measurement devices 50 can be disposed between different parts of the plurality of parts of the frame 100.

According to one preferred embodiment and as shown in FIGS. 59 to 61, by way of a non-limiting example, the frame 100 comprises a first part 101 and a second part 102. The measurement device 50 is cleverly located between the first part 101 and the second part 102 such that, on the one hand, the two parts are rigidly connected to one another, and on the other hand the force sensor 51 is suspended in such a way that any leaning force applied to the frame 100 cannot interfere with a weight measurement.

FIG. 56 shows that the front part 103 of the container 40 advantageously comprises a flap 400 disposed at the front of the trolley 1. In this non-limiting example, the flap 400 forms a wall of the container 40. This flap 400 is configured to lower when the trolley 1 nests with another trolley 1b, preferably when the front part 103 of the container 40 receives the rear part 104 of the container 40 of another trolley 1b. According to this embodiment, the flap 400 selectively has two configurations. According to a non-limiting embodiment, a first configuration corresponds to a so-called raised configuration wherein the flap 400 extends mainly vertically, the second configuration corresponding to a so-called folded down configuration wherein the flap 400 extends mainly horizontally. Advantageously, the flap 400 comprises at least one hinge element 402. This hinge element 402 comprises a rotational axis that is preferably horizontal. This hinge element 402 advantageously comprises at least one return element configured to hold the flap in the raised configuration when the trolley 1 is not nested with another trolley 1b, preferably when it is not nested around another container of the trolley 1b.

Also in FIGS. 56 to 63, it should also be noted that the frame 100 comprises covers 35 disposed above the measurement devices 50. These covers 35 are supported by the frame 100 such that, when a force with a vertical component is applied to the frame 100 or to the cover 35, this force is transmitted to the load-bearing structure 200 and then to the chassis 10 such that this force cannot interfere with the one or more measurement devices 50, and preferably cannot interfere with the one or more weight measurements carried out by the one or more measurement devices 50.

Thus, according to the example shown in FIGS. 56 to 63, the trolley 1 comprises at least 4 measurement devices 50. Each trolley arm 11, 12 preferably carries two measurement devices 50.

These measurement devices 50 will be described in more detail hereinafter.

In FIG. 56, the trolley 1 comprises a gripping device 60 and a display device 70 as described hereinabove.

The trolley 1 thus comprises at least one container 40 suspended from the frame 100 through four measurement devices 50. According to one embodiment, as mentioned hereinabove, this container 40 comprises two parts, a front part 103 and a rear part 104. The front part 103 comprises a width dimension 103a greater than the width dimension 104a of the rear part 104. The front part 103 of the container 40 comprises the flap 400 described hereinabove. The rear part 104 of the container 40 comprises at least one rear wall 403. The front part 103 of the container 40 is suspended from the frame 100 through two measurement devices 50. More specifically, the front part 103 of the container 40 is suspended from the first arm 11 of the trolley 1 by a measurement device 50 through a suspension bar 34, and from the second arm 12 of the trolley 1 by another measurement device 50 through another suspension bar 34. The same applies for the rear part 104 of the container 40.

Finally, FIG. 56 for example shows the presence of a block comprising an electric battery 54 configured to supply electricity to all of the electrical elements of the trolley 1. This block is advantageously disposed beneath the container 40 such that the centre of gravity is as low as possible.

FIG. 57 shows a profile view of the trolley 1 shown to FIG. 56. The elements previously described are shown in this figure. The block 54 comprising a coaxiality tab 53 should in particular be noted. This coaxiality tab is configured to abut against an abutment carried by the container 40. Thus, the abutment limits the movement and thus the rocking motion of the container 40. Preferably, the abutment is formed by an opening into which the coaxiality tab 53 is inserted. The coaxiality tab 53 is configured to bear against the edge of the opening carried by the suspended container 40 so as to limit the rocking motion of said suspended container 40.

According to one embodiment, the coaxiality tab 53 can be replaced or can comprise an additional measurement device 53. This additional measurement device 53 is intended to at least partially support the container 40 and the contents thereof, and preferably to measure the weight of the container 40 and the contents thereof.

FIG. 58 shows an overhead view of a trolley 1 as shown to FIGS. 56 and 57. In this figure, as stated hereinabove, the front part 105 of the trolley 1 can be seen to be narrower than the rear part 106 of the trolley 1 so as to allow said trolley 1 to nest in at least part of another trolley 1b.

Similarly, in this figure, the front part 103 of the container 40 can be seen to be wider than the rear part 104 of the container 40 so as to allow said trolley 1 to nest around at least a part of another trolley 1b, preferably so as to allow the front part 103 of the container 40 of the trolley 1 to nest around the rear part 104 of the container 40 of the other trolley 1b.

FIG. 59 is an enlargement of a measurement device 50 disposed beneath a cover 35 and between a first part 101 of the frame 100 and a second part 102. The measurement device 50 is connected to at least part of the container 40 by a suspension bar 34. The use of a cover 35 is clever in that it only rests on the frame 100 and is not in direct mechanical contact with the measurement device 50, so that any force applied to the cover 35 and having a vertical component is not transmitted to the measurement device 50 or to the container 40, but directly to the frame 100, then to the load-bearing structure 200 and finally to the chassis 10.

FIG. 60 shows the same enlargement as that shown in FIG. 59 with the cover 35 removed. The measurement device 50 comprising a force sensor 51 is then revealed. This force sensor 51 is rigidly connected to the first part 101 of the frame 100 and to the second part 102 of the frame 100. This rigid connection is produced by connecting bars 55 and by an attachment 56 for attaching the force sensor 51. This attachment 56 rigidly connects the force sensor 51 to the connecting bars 55. This connection is clever in that it prevents any force applied to the frame 100 from interfering with the measurement of the weight of the container 40 and of the contents thereof. Moreover, the insertion of the measurement device 50 into the very structure of the frame 100 saves a large amount of space and improves ergonomics. This force sensor 51 is also rigidly connected to at least part of the container 40, preferably through a suspension bar 34.

According to one embodiment, the frame 100 comprises the connecting bars 55.

FIG. 61 is a continuation of FIG. 60, wherein the force sensor 51 is disconnected from the frame 100 for the sake of clarity in order to show the mechanical assembly of the measurement device 50 according to a clever embodiment. It can thus be noted that the container 40 is suspended from the measurement device 50, in particular from the force sensor 51, via the suspension bar 34. The container 40 is thus completely uncorrelated from the forces that may or may not be applied to the frame 100 of the trolley 1.

Advantageously, the frame 100 comprises at least one opening 107, which can take the form of a through-opening, a recess or a groove. The measurement device 50 is disposed, preferably fully housed, inside the opening 107 of the frame 100.

FIG. 62 shows a trolley 1 a nested around another trolley 1 b. As described hereinabove, the trolley 1a comprises a container 40 having a front part 103 that is wider than its rear part 104 so as to cooperate with the rear part 104 of another trolley 1b that is identical to the trolley 1a and so as to nest around the rear part 103 of the container 40 of the other trolley 1b.

In particular, and in a clever way, the rear part 104 of the container 40 of the other trolley 1b thus fits inside the front part 103 of the container 40 of the trolley 1a. When the two trolleys 1a and 1b are nested, the flap 400 of the trolley 1a is switched into the folded down configuration thereof by the rear part 104 of the container 40 of the other trolley 1b. It should also be noted that the rear part 104 of the container of a trolley 1 comprises a rear wall 403.

FIG. 63 diagrammatically shows an overhead view of the nesting of the trolley 1a with the other trolley 1b. The front part 103 of the container 40 of the trolley 1 can be seen to surround at least part of the rear part 104 of the container 40 of the other trolley 1b, and the front part 105 of the chassis 10 of the trolley 1a can be seen to nest in at least part of the rear part 106 of the chassis of the other trolley 1b.

The present invention thus enables two trolleys, each equipped with at least one device for measuring the weight of a container and of the contents thereof, to be nested in a simple, efficient and reliable manner.

In all of the above embodiments, the terms containers, trays, boxes or recipients are considered to be equivalent and can be interchanged.

The invention is not limited to the embodiments described in the non-limiting examples hereinabove, but extends to incorporate all embodiments within the scope of the claims.

### LIST OF REFERENCES

1 Trolley

1a First trolley

1b Second trolley

1c Third trolley

3 Direction of forward travel of the trolley

4 Sliding directions

10 Chassis

10a Chassis of the first trolley

10b Chassis of the second trolley

10c Chassis of the third trolley

11 First arm

12 Second arm

13 Horizontal portion

14 Vertical portion

15 Telescopic connecting portion

15a Telescopic connecting portion of the first trolley

15b Telescopic connecting portion of the second trolley

16 Telescopic portion

16a Telescopic portion of the first trolley

16b Telescopic portion of the second trolley

17 Hinge

18 Cylinder

19 Abutment

20 Bearing member

30 Suspension structure

30a Suspension structure of the first trolley

30b Suspension structure of the second trolley

31 Receiving areas

32 Top face

33 Side face

34 Suspension bar

35 Cover

40 Suspended tray, container

41 First flange

42 Second flange

43 Additional measurement device

44 Opening

50 Measurement device

51 Force sensor

52 Coaxiality tab

53 Additional force sensor

54 Electric battery

55 Connecting bar

56 Force sensor attachment

60 Gripping device

70 Display device

71 Optical scanner

80 Recipient

80a First recipient

80b Second recipient

81 First side wall

81a First side wall of the first recipient

81b First side wall of the second recipient

82 Second side wall

82a Second side wall of the recipient of the first trolley

82b Second side wall of the recipient of the second trolley

83 Rotational axis

90 Container

91 First handle

92 Second handle

100 Frame

101 First part of the frame

102 Second part of the frame

103 Front part of the container

103a Width dimension of the front part of the container

104 Rear part of the container

104a Width dimension of the rear part of the container

105 Front part of the chassis

105a Width dimension of the front part of the chassis

106 Rear part of the chassis

106a Width dimension of the rear part of the chassis

107 Opening

200 Load-bearing structure

200a Load-bearing structure of the first trolley

200b Load-bearing structure of the second trolley

300 Tray

300a Rear tray

300b Intermediate tray

300c Front tray

301 Front abutment

302 Rail

303 Bottom wall

303a Bottom wall of the rear tray

303b Bottom wall of the intermediate tray

303c Bottom wall of the front tray

304 Side wall

305 Third side wall

306 Rail

400 Flap

401 Front wall

402 Hinge element

403 Rear wall

500 Nesting direction

3040 Edges

L1 Length of the trolley

I1 Width of the trolley

L2 Length of the suspension structure

I2 Width of the suspension structure

H Height of the suspension structure

Lpfa Length of the bottom wall of the rear tray

Lpfb Length of the bottom wall of the intermediate tray

Lpfc Length of the bottom wall of the front tray

1. A trolley, comprising:
at least one chassis supported by at least three bearing members configured to isostatically support the trolley on a ground, at least two of said at least three members each comprising at least one rolling device,
a load-bearing structure supported by the chassis,
a suspension structure supported by the load-bearing structure and configured to suspend at least one container in which at least one product is intended to be placed, the trolley being configured such that the at least one container is fully suspended from the suspension structure,
a gripping device intended to be grasped by the user in order to move said trolley,
wherein
the trolley comprises at least one measurement device at least partially carried by the suspension structure and intended to measure at least one parameter relating to the weight of the at least one container when the container is suspended from the suspension structure,
the suspension structure of said trolley is shaped to cooperate with the suspension structure of another trolley so as to allow said trolley to be at least partially nested in said other trolley by cooperation between the suspension structure of said trolley and the suspension structure of said other trolley.

2. The trolley according to claim 1, wherein the measurement device is carried entirely by the suspension structure.

3. The trolley according to claim 1, wherein the measurement device comprises at least one force sensor for measuring the parameter relating to the weight of the at least one container and of the at least one product contained therein, said force sensor comprising a strain gauge.

4. The trolley according to claim 1, configured such that when a force applied by a user to the gripping device has a vertical component, this vertical component is transmitted from the gripping device to the chassis and then to the ground.

5. The trolley according to claim 1, comprising at least one frame carried by the chassis, the frame being configured so that when a force, having a vertical component, is applied by a user to the frame, this vertical component is transmitted from the frame to the chassis and then to the ground without being transmitted to the suspension structure.

6. The trolley according to claim 5, comprising at least one cover supported by the frame and disposed above the measurement device such that when a force, having a vertical component, is applied by a user to the cover, this vertical component is transmitted from the cover to the frame, then to the chassis and then to the ground without being transmitted to the suspension structure.

7. The trolley according to claim 5, wherein the measurement device is suspended from the frame.

8. The trolley according to claim 5, wherein the frame comprises at least one opening and wherein the measurement device is disposed inside the opening.

9. The trolley according to claim 1, wherein the suspension structure is configured to suspend at least one container.

10. The trolley according to claim 1 comprising at least one container in which at least one product is to be placed.

11. The trolley according to claim 10, wherein the at least one container is rigid.

12. The trolley according to claim 10, wherein the container is rigidly connected to the trolley.

13. The trolley according to claim 10, wherein the suspension structure, the at least one container and the chassis of said trolley are shaped so as to cooperate with the suspension structure, the at least one container and the chassis of another trolley so as to allow at least a part of said trolley to be at least partially nested inside at least a part of said other trolley by cooperation between the suspension structure, the at least one container and the chassis of said trolley, and the suspension structure, the at least one container and the chassis of said other trolley.

14. The trolley according to claim 10, wherein the suspension structure, the at least one container and the chassis of said trolley are shaped so as to cooperate with the suspension structure, the at least one container and the chassis of another trolley so as to allow at least a part of said other trolley to be at least partially nested inside at least a part of said trolley by cooperation between the suspension structure, the at least one container and the chassis of said other trolley, and the suspension structure, the at least one container and the chassis of said trolley.

15. The trolley according to claim 10, wherein the container has a front part and a rear part, the front part having a first width dimension, the rear part having a second width dimension, the first width dimension) being greater than the second width dimension.

16. The trolley according to 15, wherein the front part of the container is configured to surround at least part of the rear part of the container of another trolley in the storage configuration.

17. The trolley according to claim 10, wherein the container comprises at least one flap disposed at the front of said container, said flap being rigidly connected to the container through at least one hinge element comprising at least one rotational axis, said flap being configured to selectively have a first configuration wherein the flap defines a wall of the container and a second configuration wherein the flap extends along a wall of the container, the flap being configured to be capable of moving in rotation about said rotational axis so as to selectively switch from the first configuration to the second configuration.

18. (canceled)

19. (canceled)

20. The trolley according to claim 10, comprising at least one coaxiality tab at least partially carried by the chassis, configured to engage an abutment carried by the container, the cooperation between the coaxiality tab and the abutment being intended to limit the rocking motion of said container.

21. The trolley according to claim 1, wherein the chassis has a front part and a rear part, the front part having a first width dimension, the rear part having a second width dimension, the first width dimension being greater than the second width dimension.

22. The trolley according to the preceding claim 21, wherein the front part of the chassis is configured to nest inside at least part of the rear part of the chassis of another trolley in the storage configuration.

23. (canceled)

24. (canceled)

25. (canceled)
